(19) United States
(12) Patent Application Publication
(10) Pub. No.: US 2026/0023166 A1
(43) Pub. Date: Jan. 22, 2026

(54) DISTANCE MEASURING DEVICE

(71) Applicant: Nuvoton Technology Corporation Japan, Kyoto (JP)

(72) Inventors: Masahiko NISHIMOTO, Kyoto (JP); Toru YAMADA, Kyoto (JP); Tetsuro OKUYAMA, Kyoto (JP)

(21) Appl. No.: 19/339,689

(22) Filed: Sep. 25, 2025

Related U.S. Application Data
(63) Continuation of application No. PCT/JP2024/009892, filed on Mar. 13, 2024.
(60) Provisional application No. 63/493,518, filed on Mar. 31, 2023.

(51) Int. Cl. G01S 7/4863; G01S 7/481; G01S 7/4865; G01S 7/4914; G01S 17/10; G01S 17/32

(52) U.S. Cl. CPC G01S 7/4863; G01S 7/4865; G01S 7/4914; G01S 17/10; G01S 17/32; G01S 7/4815

(57) ABSTRACT

A distance measuring device that outputs one or more distance information items each indicating a distance to a subject, the distance measuring device includes: a light source that emits illumination light including one or more bright portions; a light receiver that includes a pixel array in which pixels are arranged in a matrix; a distance information calculator that calculates, for each of the pixels, pixel distance information indicating a distance from the pixel to the subject when the light receiver receives reflected light that is the illumination light reflected off the subject; a distance information selector that selects one or more selective distance information items from among the pixel distance information items corresponding to the pixels; and an outputter that outputs the one or more distance information items, based on the one or more selective distance information items.

### CROSS REFERENCE TO RELATED APPLICATIONS

This is a continuation application of PCT International Patent Application No. PCT/JP2024/009892 filed on Mar. 13, 2024, designating the United States of America, which is based on and claims priority of U.S. Provisional Patent Application No. 63/493,518 filed on Mar. 31, 2023. The entire disclosures of the above-identified applications, including the specifications, drawings and claims are incorporated herein by reference in their entirety.

### FIELD

The present disclosure relates to a distance measuring device.

### BACKGROUND

Distance measuring devices that output distance information indicating a distance to a subject have been conventionally known (for example, see Patent Literature (PTL) 1).

### CITATION LIST

### Patent Literature

PTL 1: Japanese Unexamined Patent Application Publication No. 2022-165344

### SUMMARY

### Technical Problem

Distance measuring devices that output distance information that is much more accurate than distance information output by conventional distance measuring devices are sought after.

In view of the above, the present disclosure provides a distance measuring device that can output distance information that is much more accurate than distance information output by conventional distance measuring devices.

### Solution to Problem

A distance measuring device according to one aspect of the present disclosure is a distance measuring device that outputs one or more distance information items each indicating a distance to a subject. The distance measuring device includes: a light source that emits illumination light including one or more bright portions having luminance higher than ambient luminance; a light receiver that includes a pixel array in which pixels are arranged in a matrix, the pixels each sequentially outputting pixel values that are based on exposure amounts; a distance information calculator that calculates, for each of the pixels, light intensity information and pixel distance information based on one or more of the pixel values sequentially output by the pixel when the light receiver receives reflected light that is the illumination light reflected off the subject, the light intensity information indicating an intensity of the reflected light at the pixel, the pixel distance information indicating a distance from the pixel to the subject; a distance information selector that selects, based on the light intensity information items corresponding to the pixels, one or more selective distance information items from among the pixel distance information items corresponding to the pixels; and an outputter that outputs the one or more distance information items, based on the one or more selective distance information items.

### Advantageous Effects

A distance measuring device according to one aspect of the present disclosure can provide a distance measuring device that can output distance information that is much more accurate than distance information output by conventional distance measuring devices.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating one example of a configuration of a distance measuring device according to Embodiment 1.

FIG. 2 is a schematic diagram illustrating one example of illumination light according to Embodiment 1.

FIG. 3 is a schematic diagram illustrating an example of variations of illumination light according to Embodiment 1.

FIG. 4 is an enlarged schematic diagram illustrating a state of reflected light condensed on a surface of a pixel array according to Embodiment 1.

FIG. 5 is a schematic diagram illustrating one example of a state in which a distance information calculator according to Embodiment 1 calculates light intensity information and pixel distance information.

FIG. 6 is a schematic diagram illustrating another example of the state in which the distance information calculator according to Embodiment 1 calculates light intensity information and pixel distance information.

FIG. 7 is a schematic diagram illustrating one example of a state in which a distance information selector according to Embodiment 1 selects selective distance information.

FIG. 8 is a schematic diagram illustrating another example of the state in which the distance information selector according to Embodiment 1 selects selective distance information.

FIG. 9 is a flowchart showing a first distance-measuring process performed by the distance measuring device according to Embodiment 1.

FIG. 10 is a schematic diagram illustrating one example of a state in which the distance information selector according to Embodiment 1 selects selective distance information.

FIG. 11 is a schematic diagram illustrating one example of a state in which stray light is emitted on a subject.

FIG. 12 is a block diagram illustrating one example of a configuration of a distance measuring device according to Variation 1.

FIG. 13 is a flowchart showing a second distance-measuring process performed by the distance measuring device according to Variation 1.

FIG. 14 is a block diagram illustrating one example of a configuration of a distance measuring device according to Variation 2.

FIG. 15 is a schematic diagram illustrating one example of a state in which an outputter according to Variation 2 calculates distance information.

FIG. 16 is a block diagram illustrating one example of a configuration of a distance measuring device according to Variation 3.

FIG. 17 is a schematic diagram illustrating an example of variations of first illumination light and second illumination light according to Variation 3.

FIG. 18 is a schematic diagram illustrating one example of a state in which a first light source according to Variation 3 emits illumination light including one or more bright portions and a second light source according to Variation 3 emits surface illumination light.

FIG. 19 is a block diagram illustrating one example of a configuration of a distance measuring device according to Variation 4.

FIG. 20 is a schematic diagram illustrating one example of a state in which operation performed on a light source by a light source actuator according to Variation 4 changes positions of one or more bright portions on a subject.

FIG. 21 is a block diagram illustrating one example of a configuration of a distance measuring device according to Variation 5.

FIG. 22 is a schematic diagram illustrating one example of a state in which a light source according to Variation 5 switches areas of one or more bright portions included in illumination light.

FIG. 23 is a block diagram illustrating one example of a configuration of a distance measuring device according to Embodiment 2.

FIG. 24A is an image illustration showing one example of a template according to Embodiment 2.

FIG. 24B is an image illustration showing one example of a template according to Embodiment 2.

FIG. 24C is an image illustration showing one example of the template according to Embodiment 2.

FIG. 24D is an image illustration showing one example of the template according to Embodiment 2.

FIG. 25 is an image illustration showing one example of the template according to Embodiment 2.

FIG. 26 is a schematic diagram illustrating one example of a state in which a matching processor according to Embodiment 2 performs a matching process.

FIG. 27 is a block diagram illustrating one example of a configuration of a distance measuring device according to Variation 6.

FIG. 28 is a block diagram illustrating one example of a configuration of a distance measuring device according to Variation 7.

FIG. 29 is a block diagram illustrating one example of a configuration of a distance measuring device according to Variation 8.

FIG. 30 is a block diagram illustrating one example of a configuration of a distance measuring device according to Variation 9.

FIG. 31 is a block diagram illustrating one example of a configuration of a distance measuring device according to Variation 10.

### DESCRIPTION OF EMBODIMENTS

### (Circumstances Leading to One Aspect of the Present Disclosure)

The inventors have been working on the development of a distance measuring device that outputs distance information indicating a distance to a subject.

Through this development, the inventors have gained the following knowledge about distance information calculation: when a distance measuring device emits illumination light including one or more bright portions having luminance higher than ambient luminance onto a subject and receives reflected light that is the illumination light reflected off the subject, distance information calculated based on pixel values of pixels positioned in an area of the bright portions and/or a particular area within an area surrounding the bright portions is much more accurate than distance information calculated based on pixel values of pixels positioned in other areas.

Based on the knowledge, the inventors have conducted experiments and studies over and over. Consequently, the inventors have arrived at a distance measuring device according to the present disclosure as described below.

A distance measuring device according to one aspect of the present disclosure is a distance measuring device that outputs one or more distance information items each indicating a distance to a subject. The distance measuring device includes: a light source that emits illumination light including one or more bright portions having luminance higher than ambient luminance; a light receiver that includes a pixel array in which pixels are arranged in a matrix, the pixels each sequentially outputting pixel values that are based on exposure amounts; a distance information calculator that calculates, for each of the pixels, light intensity information and pixel distance information based on one or more of the pixel values sequentially output by the pixel when the light receiver receives reflected light that is the illumination light reflected off the subject, the light intensity information indicating an intensity of the reflected light at the pixel, the pixel distance information indicating a distance from the pixel to the subject; a distance information selector that selects, based on the light intensity information items corresponding to the pixels, one or more selective distance information items from among the pixel distance information items corresponding to the pixels; and an outputter that outputs the one or more distance information items, based on the one or more selective distance information items.

According to the distance measuring device having the above-described configuration, one or more distance information items can be output based on one or more pixel distance information items calculated based on pixel values of pixels positioned in a particular area in which pixel distance information that is much more accurate than pixel distance information calculated based on pixel values of pixels positioned in other areas can be calculated.

According to the distance measuring device having the above-described configuration, a distance measuring device that can output distance information much more accurate than distance information output by conventional distance measuring devices can therefore be provided.

Moreover, when the light receiver receives the reflected light, each of the one or more bright portions included in the reflected light are received by M (M is an integer of three or more) pixels among the pixels. As the one or more selective distance information items, the distance information selector may select, for each of the one or more bright portions included in the reflected light, the pixel distance information corresponding to a maximum light intensity pixel that corresponds to the light intensity information indicating a maximum intensity out of one or more of the pixels at which intensities of the reflected light indicated by corresponding ones of the light intensity information items are not saturated among the M pixels.

In addition, the outputter may output the one or more selective distance information items as the one or more distance information items.

Furthermore, for each of the one or more selective distance information items, the outputter may calculate the distance information based on the selective distance information and one or more of the pixel distance information items corresponding to one or more of the pixels adjacent to the maximum light intensity pixel corresponding to the selective distance information, and may output the distance information calculated.

Moreover, the distance measuring device may further include a corrector that corrects (i) low light intensity information that is the light intensity information indicating a relatively low intensity of the reflected light to corrected light intensity information indicating a greater intensity of the reflected light and (ii) high light intensity information that is the light intensity information indicating a relatively high intensity of the reflected light to the corrected light intensity information indicating an intensity of the reflected light as is. The distance information calculator may calculate the pixel distance information for each of the pixels based on the corrected light intensity information, and the distance information selector may select the one or more selective distance information items based on the corrected light intensity information.

In addition, the illumination light may include first illumination light and second illumination light that are different in a pattern of the one or more bright portions, and the light source may include a first light source that emits the first illumination light and a second light source that emits the second illumination light.

Furthermore, the first light source and the second light source may alternately emit light.

Moreover, the first light source and the second light source may simultaneously emit light.

In addition, the distance measuring device may further include a light source actuator that actuates the light source to change positions of the one or more bright portions on the subject.

Furthermore, the distance measuring device may further include a storage that stores a template pertaining to intensity distribution of the reflected light in the one or more bright portions included in the reflected light and a matching processor that calculates, for each of the pixels, a similarity degree indicating a degree of similarity between (i) intensity distribution of the reflected light indicated by N (N is an integer of two or more) light intensity information items corresponding to N pixels consisting of the pixel and N−1 pixels surrounding the pixel and (ii) the intensity distribution of the reflected light indicated by the template, where the N light intensity information items each are the light intensity information and the N pixels are among the pixels. The distance information selector may select, as the one or more selective distance information items, the pixel distance information corresponding to a pixel having the similarity degree that satisfies a predetermined condition among the pixels.

Moreover, the distance measuring device may further include: a storage that stores a template pertaining to a feature of intensity of the reflected light in the one or more bright portions in the reflected light; a feature calculator that calculates, for each of the pixels, features of intensities of the reflected light indicated by N (N is an integer of two or more) light intensity information items corresponding to N pixels consisting of the pixel and N−1 pixels surrounding the pixel, where the N light intensity information items each are the light intensity information and the N pixels are among the pixels; and a matching processor that calculates a similarity degree indicating a degree of similarity between the N features calculated by the feature calculator and the feature of the intensity of the reflected light indicated by the template. The distance information selector may select, as the one or more selective distance information items, the pixel distance information corresponding to a pixel having the similarity degree that satisfies a predetermined condition among the pixels.

In addition, the predetermined condition may be a condition that the similarity degree is greater than a predetermined threshold.

Furthermore, the distance measuring device may further include a coring part that performs a coring process on the similarity degree to calculate a core similarity degree. The predetermined condition may be a condition that the core similarity degree is greater than a predetermined threshold.

Moreover, the distance measuring device may further include: a storage that stores a machine learning model trained in advance to output, in response to an input of N (N is an integer of two or more) light intensity information items corresponding to N pixels consisting of one optional pixel and N−1 pixels surrounding the one optional pixel among the pixels, a confidence level indicating a degree of confidence that the pixel distance information corresponding to the one optional pixel is one of the one or more selective distance information items, where the N light intensity information items each are the light intensity information; and a matching processor that calculates, for each of the pixels, the confidence level of the pixel using the machine learning model. The distance information selector may select, as the one or more selective distance information items, the pixel distance information corresponding to a pixel having the confidence level that satisfies a predetermined condition among the pixels.

In addition, the predetermined condition may be a condition that the confidence level is greater than a predetermined threshold.

Furthermore, the distance measuring device may further include a coring part that performs a coring process on the confidence level to calculate a core confidence level. The predetermined condition may be a condition that the core confidence level is greater than a predetermined threshold.

Hereinafter, specific examples of a distance measuring device according to one aspect of the present disclosure will be described with reference to the drawings. Embodiments described here each show a specific example of the present disclosure. Therefore, the numerical values, shapes, elements, the arrangement and connection of the elements, steps (processes), orders of the steps, etc., described in the embodiments below are mere examples, and thus are not intended to limit the present disclosure. In addition, the drawings are schematic diagrams, and do not necessarily provide strictly accurate illustrations. Throughout the drawings, the same reference numeral is given to substantially the same element, and redundant descriptions may be omitted or simplified.

### Embodiment 1

### [Configuration]

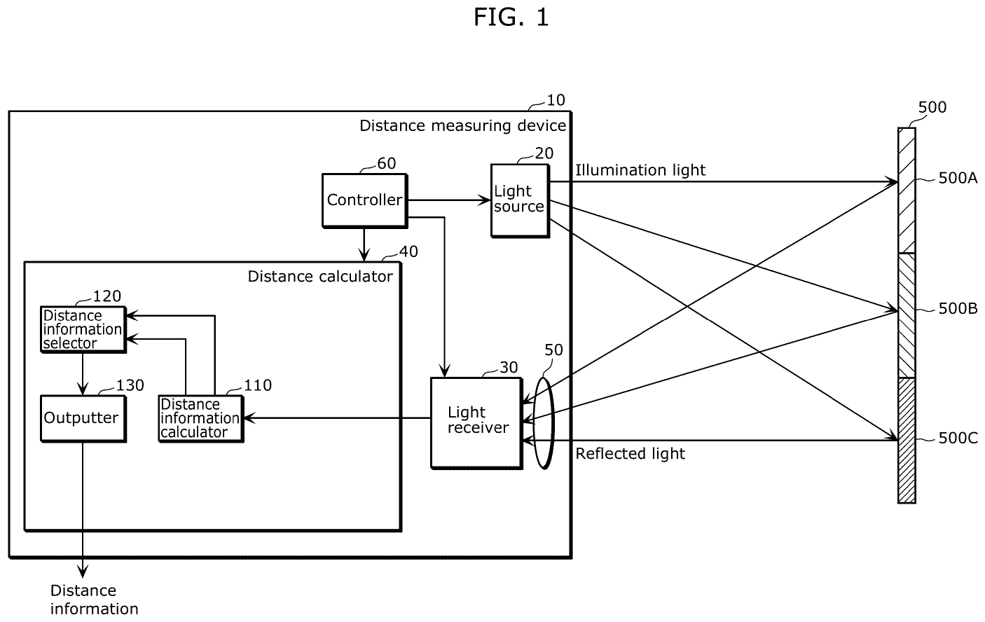

FIG. 1 is a block diagram illustrating one example of a configuration of distance measuring device 10 according to Embodiment 1.

Distance measuring device 10 shown in FIG. 1 outputs one or more distance information items each indicating a distance to subject 500.

As shown in FIG. 1, distance measuring device 10 includes light source 20, light receiver 30, distance calculator 40, optical system 50, and controller 60. Moreover, distance calculator 40 includes distance information calculator 110, distance information selector 120, and outputter 130.

Controller 60 controls light source 20, light receiver 30, and distance calculator 40.

Light source 20 emits illumination light including one or more bright portions having luminance higher than ambient luminance. The illumination light may be, for example, infrared light or visible light.

A timing at which light source 20 emits light is controlled by, for example, controller 60.

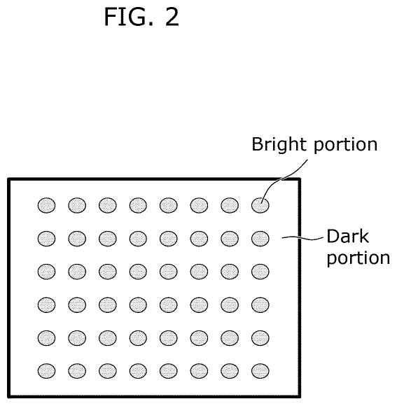

FIG. 2 is a schematic diagram illustrating one example of illumination light emitted by light source 20.

As shown in FIG. 2, illumination light emitted by light source 20 includes one or more bright portions having luminance higher than ambient luminance and a dark portion having luminance lower than the luminance of the bright portions.

The illumination light shown in FIG. 2 is only an example of illumination light emitted by light source 20. Accordingly, illumination light emitted by light source 20 need not necessarily be limited to illumination light exactly like the illumination light shown in FIG. 2.

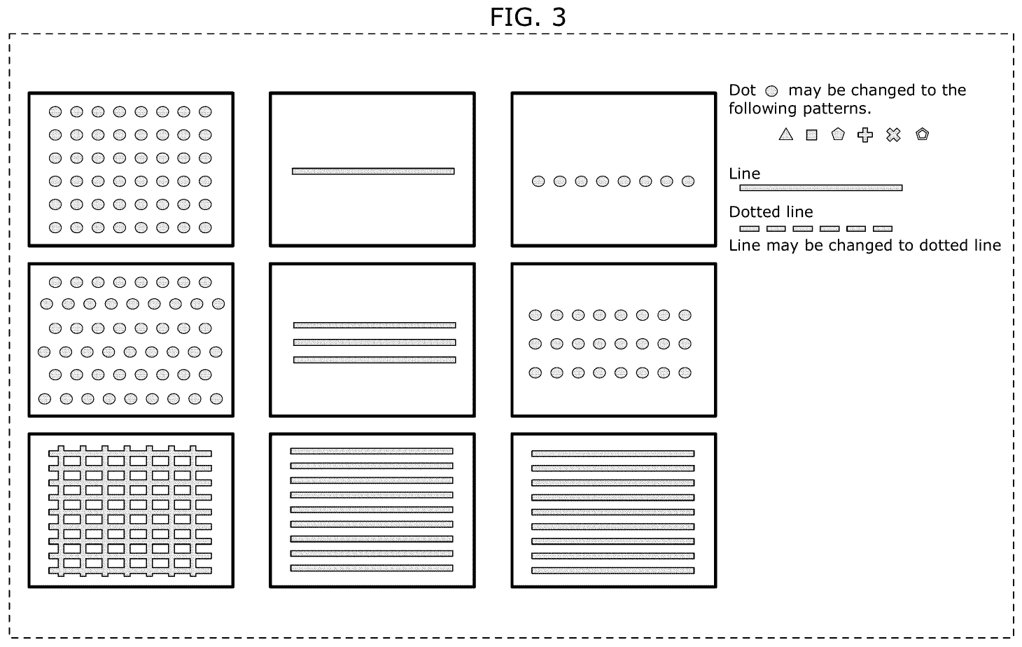

FIG. 3 is a schematic diagram illustrating an example of variations of illumination light emitted by light source 20.

As shown in FIG. 2 and FIG. 3, illumination light emitted by light source 20 is to be illumination light including one or more bright portions.

Going back to FIG. 1 again to continue with description of the configuration of distance measuring device 10.

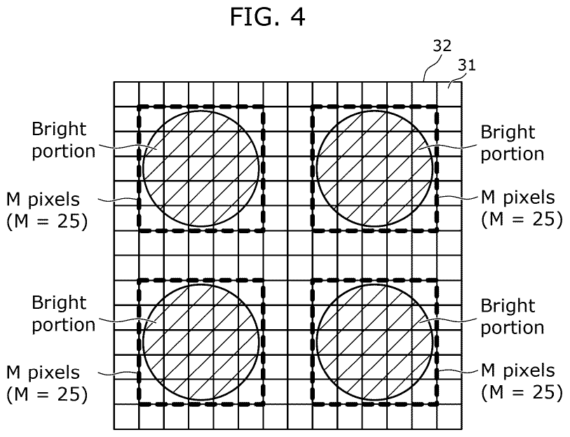

Light receiver 30 includes pixel array 32 (see FIG. 4 to be described later) consisting of a plurality of pixels 31 (see FIG. 4 to be described later) arranged in a matrix.

When light receiver 30 receives reflected light that is illumination light emitted from light source 20 and reflected off subject 500, light receiver 30 outputs pixel values (to be described later) that are based on exposure amounts of respective pixels 31 included in light receiver 30.

Each pixel 31 generates an electric charge corresponding to an exposure amount each time pixel 31 is exposed to light, and outputs a pixel value corresponding to the generated electric charge. In other words, each pixel 31 sequentially outputs pixel values that are based on exposure amounts.

A timing at which pixels 31 are exposed to light and a timing at which pixels 31 output pixel values are controlled by, for example, controller 60.

Optical system 50 condenses reflected light, which is illumination light emitted from light source 20 and reflected off subject 500, on a surface of pixel array 32.

FIG. 4 is an enlarged schematic diagram illustrating a portion of a surface of pixel array 32, showing a state of reflected light condensed on the surface of pixel array 32 by optical system 50. The reflected light is illumination light emitted from light source 20 and reflected off subject 500.

As shown in FIG. 4, each of one or more bright portions included in the reflected light is condensed on a surface of M (M is an integer of three or more) pixels 31 among the plurality of pixels 31 that constitute pixel array 32, regardless of a distance from distance measuring device 10 to subject 500.

Accordingly, each of the one or more bright portions included in the reflected light is received by a set of M pixels 31 among the plurality of pixels 31 that constitute pixel array 32.

Note that although FIG. 4 shows an example in which M is 25, an example in which M is 25 is one example. As long as M is an integer of three or more, M need not necessarily be limited to 25. Furthermore, M may be different in number for each of positions of pixels.

Going back to FIG. 1 again to continue with description of the configuration of distance measuring device 10.

Distance information calculator 110 calculates, for each of the plurality of pixels 31, light intensity information indicating intensity of reflected light at the pixel 31 and pixel distance information indicating a distance from the pixel 31 to subject 500, based on one or more pixel values sequentially output by the pixel 31.

Distance information calculator 110 may calculate the light intensity information and pixel distance information using, for example, a known pulse time of flight (TOF) method or a known continuous wave (CW) TOF method.

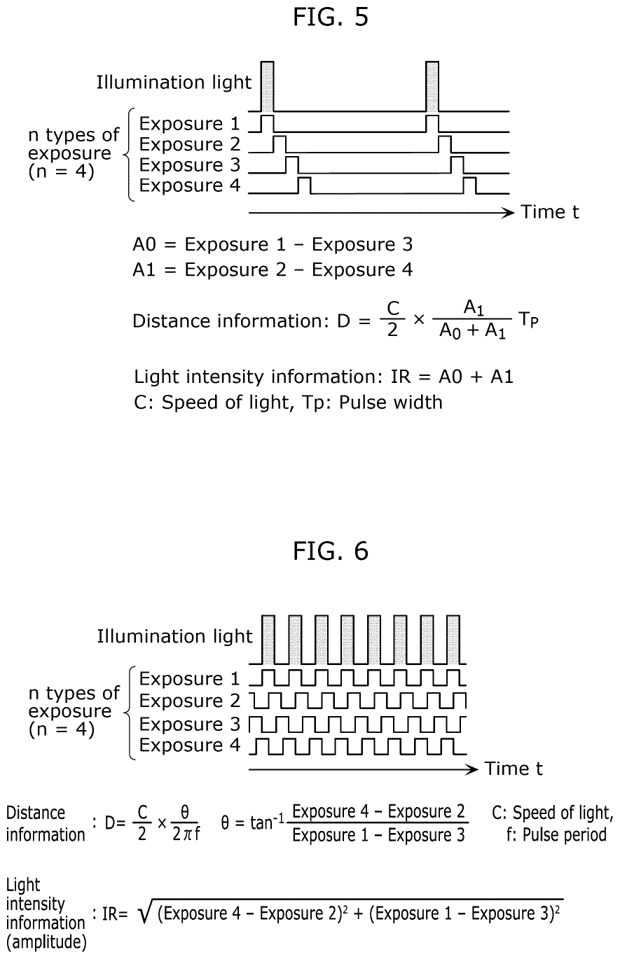

FIG. 5 is a schematic diagram illustrating a state in which distance information calculator 110 calculates light intensity information and pixel distance information using the pulse TOF method. FIG. 6 is a schematic diagram illustrating a state in which distance information calculator 110 calculates light intensity information and pixel distance information using the CWTOF method.

Going back to FIG. 1 again to continue with description of the configuration of distance measuring device 10.

Based on light intensity information items corresponding to respective pixels 31, distance information selector 120 selects one or more selective distance information items from among pixel distance information items corresponding to respective pixels 31.

More specifically, as the one or more selective distance information items, distance information selector 120 selects, for each of one or more bright portions included in reflected light, pixel distance information corresponding to the maximum light intensity pixel that corresponds to light intensity information indicating the maximum intensity out of one or more pixels 31 at which intensities of the reflected light indicated by corresponding light intensity information items are not saturated among M pixels 31 that receive light of the bright portion.

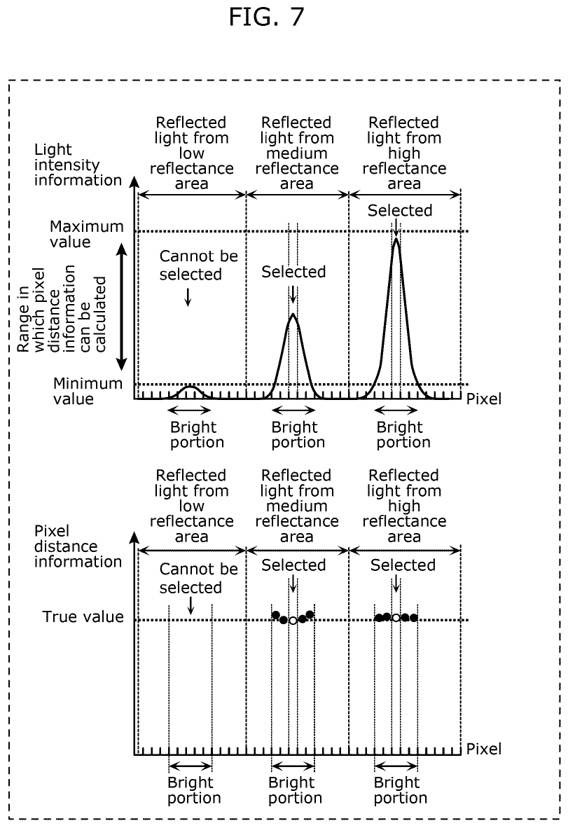

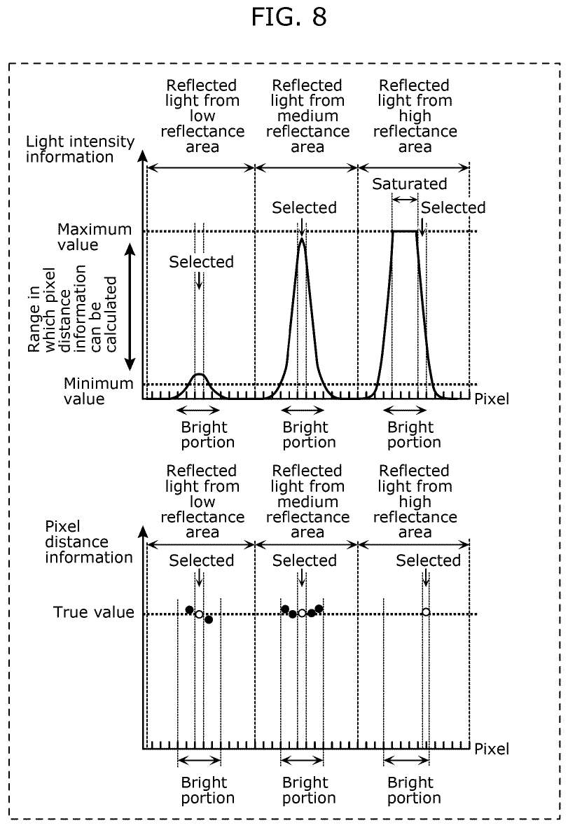

FIG. 7 and FIG. 8 are schematic diagrams each illustrating a state in which distance information selector 120 selects selective distance information for each of one or more bright portions included in reflected light, when sets of M pixels 31 that receive light of the bright portions are arranged in a line in a column direction.

Here, FIG. 7 is a schematic diagram illustrating cases in which (1) intensities of reflected light indicated by light intensity information items corresponding to reflected light from low reflectance area 500A (see FIG. 1) of subject 500 are less than an intensity required to calculate pixel distance information, (2) intensities of reflected light indicated by light intensity information items corresponding to reflected light from medium reflectance area 500B (see FIG. 1) and high reflectance area 500C (see FIG. 1) of subject 500 are greater than the intensity required to calculate pixel distance information, and (3) the intensities of the reflected light indicated by the light intensity information items corresponding to the reflected light from high reflectance area 500C are not saturated. FIG. 8 is a schematic diagram illustrating cases in which (1) intensities of reflected light indicated by light intensity information items corresponding to reflected light from low reflectance area 500A, medium reflectance area 500B, and high reflectance area 500C of subject 500 are greater than the intensity required to calculate pixel distance information and (2) intensities of the reflected light indicated by some of light intensity information items among the light intensity information items corresponding to the reflected light from high reflectance area 500C are saturated.

For example, when, as shown in FIG. 7, the intensities of reflected light indicated by light intensity information items corresponding to reflected light from low reflectance area 500A are less than an intensity required to calculate pixel distance information, the intensities of the reflected light indicated by the light intensity information items corresponding to reflected light from low reflectance area 500A can be increased to be greater than the intensity required to calculate the pixel distance information by, for example, increasing the intensity of illumination light emitted by light source 20. With this, even if intensities of the reflected light indicated by some of light intensity information items among light intensity information items corresponding to the reflected light from high reflectance area 500C are saturated as shown in FIG. 8, selection of selective distance information in a dynamic range of from reflected light from low reflectance area 500A to reflected light from high reflectance area 500C can be achieved.

Going back to FIG. 1 again to continue with description of the configuration of distance measuring device 10.

Outputter 130 outputs one or more distance information items each indicating a distance to subject 500, based on one or more selective distance information items selected by distance information selector 120.

More specifically, outputter 130 outputs the one or more selective distance information items selected by distance information selector 120 as one or more distance information items each indicating a distance to subject 500.

### [Operation]

Hereinafter, operation performed by distance measuring device 10 having the above-described configuration will be described.

Distance measuring device 10 performs a first distance-measuring process to measure a distance to subject 500.

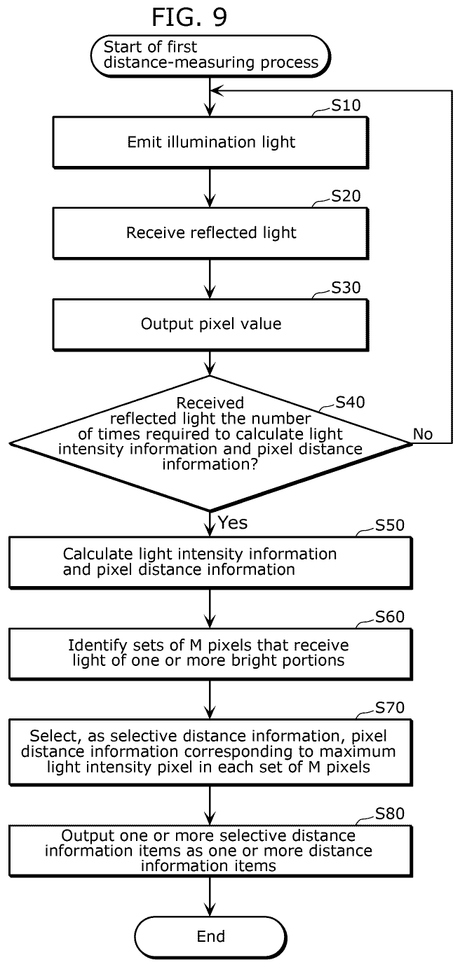

FIG. 9 is a flowchart showing a first distance-measuring process performed by distance measuring device 10.

The first distance-measuring process starts by a user who uses distance measuring device 10 performing an operation to start the first distance-measuring process on distance measuring device 10 in a state in which the user is holding distance measuring device 10 in a direction in which illumination light travels toward subject 500.

When the first distance-measuring process is started, light source 20 emits illumination light toward subject 500 (step S10).

Pixels 31 thereupon receive reflected light that is the illumination light reflected off subject 500 (step S20), and output pixel values that are based on reflected light exposure amounts (step S30).

When the number of times each pixel 31 receives light fails to reach the number of times required by distance information calculator 110 to calculate light intensity information and pixel distance information (No in step S40), the process proceeds to step S10 again.

When, in the process of step S40, the number of times each pixel 31 receives light reaches the number of times required by distance information calculator 110 to calculate the light intensity information and pixel distance information (Yes in step S40), distance information calculator 110 calculates, for each pixel 31, the light intensity information and pixel distance information based on one or more pixel values output from the pixel 31 (step S50).

When the light intensity information items and pixel distance information items are calculated, distance information selector 120 identifies sets of M pixels 31 that receive light of one or more bright portions included in the reflected light, based on the light intensity information items corresponding to respective pixels 31 (step S60).

For example, distance information selector 120 may identify sets of M pixels 31 that receive light of the one or more bright portions included in the reflected light by segmenting pixels 31 through blob analysis using the light intensity information items corresponding to respective pixels 31.

When the sets of M pixels 31 that receive light of the one or more bright portions included in the reflected light are identified, distance information selector 120 selects, for each of the identified sets of M pixels 31, as selective distance information, pixel distance information corresponding to the maximum light intensity pixel that corresponds to light intensity information indicating the maximum intensity out of one or more pixels 31 at which intensities of the reflected light indicated by corresponding light intensity information items are not saturated among the identified set of M pixels 31 (step S70).

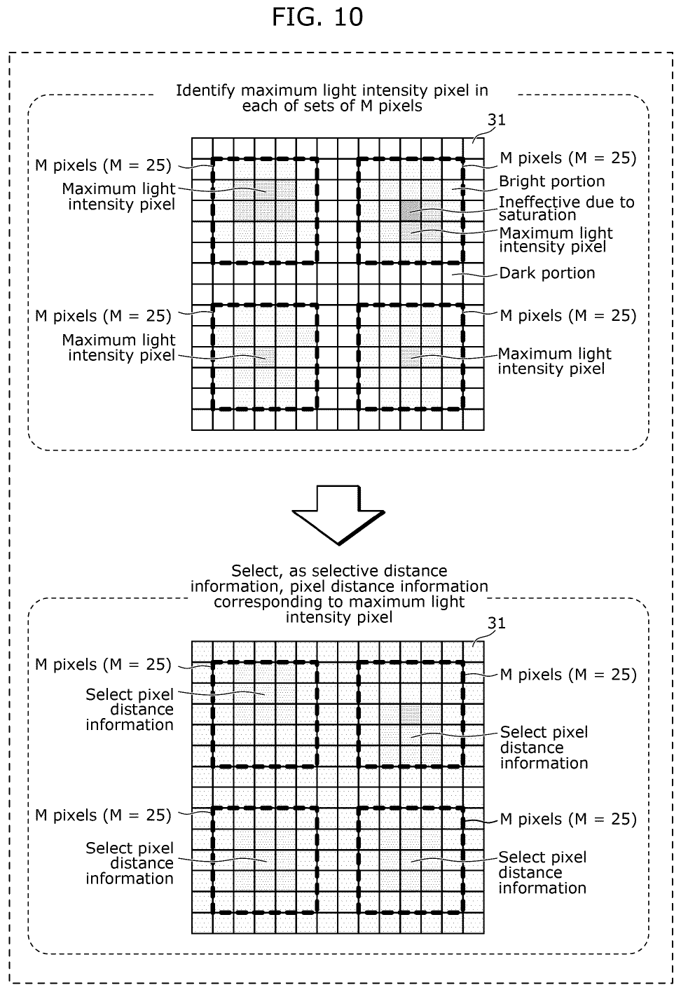

FIG. 10 is a schematic diagram illustrating one example of a state in which distance information selector 120 identifies, for each of sets of M pixels 31, the maximum light intensity pixel that corresponds to light intensity information indicating light intensity information indicating the maximum intensity among light intensity information items corresponding to one or more pixels 31 among the set of M pixels 31, and selects pixel distance information that corresponds to the identified maximum light intensity pixel as selective distance information.

Going back to FIG. 9 again to continue with a description of the first distance-measuring process.

When the one or more selective distance information items are selected, outputter 130 outputs the one or more selective distance information items that have been selected as one or more distance information items each indicating a distance to subject 500 (step S80).

When the process of step S80 ends, distance measuring device 10 ends the first distance-measuring process.

### [Study]

According to distance measuring device 10, even when, as shown in FIG. 8, subject 500 includes high reflectance area 500C in which some of intensities of bright portions in reflected light are saturated, exceeding an intensity required to calculate pixel distance information, distance information selector 120 can select pixel distance information indicating a distance to high reflectance area 500C as selective distance information.

For this reason, distance measuring device 10 can calculate distance information indicating a distance to high reflectance area 500C.

Whereas, the conventional distance measuring device according to the comparative example that includes a light source that emits surface illumination light (floodlight) that causes the entire illuminated surface to have a uniform intensity cannot accurately calculate distance information indicating a distance to high reflectance area 500C, when subject 500 includes high reflectance area 500C in which an intensity of reflected light is saturated, exceeding an intensity required to calculate pixel distance information.

As described above, distance measuring device 10 can output distance information that is much more accurate than distance information output by the above-described conventional distance measuring device according to the comparative example.

Moreover, as described above, distance measuring device 10 includes distance information selector 120 that can achieve selection of selective distance information in a dynamic range of from reflective light from low reflectance area 500A to reflective light from high reflectance area 500C.

For this reason, distance measuring device 10 can achieve the dynamic range of from low reflectance area 500A to high reflectance area 500C in the calculation of distance information.

Whereas the above-described conventional comparative example cannot accurately calculate distance information indicating a distance to high reflectance area 500C as described above.

For this reason, the above-described conventional distance measuring device according to the comparative example can only achieve a dynamic range of from low reflectance area 500A to medium reflectance area 500B in the calculation of distance information.

As described above, distance measuring device 10 can achieve, in the calculation of distance information, a dynamic range wider than the dynamic range of the above-described conventional distance measuring device according to the comparative example.

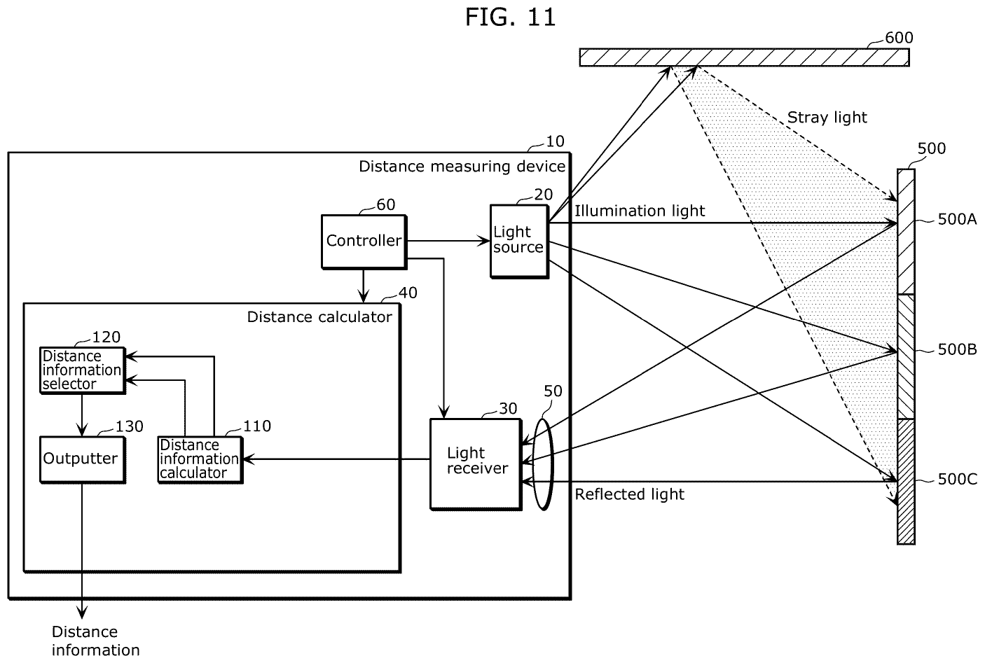

FIG. 11 is a schematic diagram illustrating one example of a state in which stray light that is illumination light emitted by light source 20 and diffused due to object 600 is emitted onto subject 500. Here, the description is based on the following: (1) diffusion of illumination light caused by object 600 is predominantly Lambertian diffusion, (2) an intensity of light of a dark portion is zero, (3) the ratio of the area size of a section of bright portions to the entirety of the illumination light is 1/K, and (4) if the illumination light emitted from light source 20 is surface illumination light, an intensity of stray light on a surface of subject 500 is 1/L of an intensity of the illumination light on the surface of subject 500.

In this case, when an intensity of a bright portion on the surface of subject 500 is denoted by S, the sum of an intensity of a bright portion and an intensity of stray light (S1) on the surface of subject 500 is expressed by S1=S+S×1/K×1/L=S+S/(K×L), and the sum of an intensity of a dark portion and the intensity of the stray light (S2) on the surface of subject 500 is expressed by S2=0+S×1/K×1/L=S/(K×L).

In other words, in the calculation of distance information in this case, a ratio of intensity S/(K×L) of the stray light, which becomes a noise component on the surface of subject 500, to intensity S of the bright portion on the surface of subject 500 is 1/(K×L).

Whereas, when the above-described conventional distance measuring device according to the comparative example emits surface illumination light, where S denotes an intensity of the surface illumination light on the surface of subject 500, the sum of an intensity of the surface illumination light and the intensity of stray light (S3) on the surface of subject 500 is expressed by S3=S+S×1/L=S+S/L.

In other words, in the calculation of distance information in this case, a ratio of intensity S/K of stray light, which becomes a noise component on the surface of subject 500, to intensity S of the surface illumination light on the surface of subject 500 is 1/K.

As described above, distance measuring device 10 can output distance information that is much more accurate than distance information output by the above-described conventional distance measuring device according to the comparative example.

### Variation 1

Hereinafter, a distance measuring device according to Variation 1 will be described. The distance measuring device according to Variation 1 has a partly changed configuration from the configuration of distance measuring device 10 according to Embodiment 1.

Detailed description of the distance measuring device according to Variation 1 will be omitted since the elements the same as those of distance measuring device 10 have been already described and are given the same reference numerals. Here, differences from distance measuring device 10 will be mainly described.

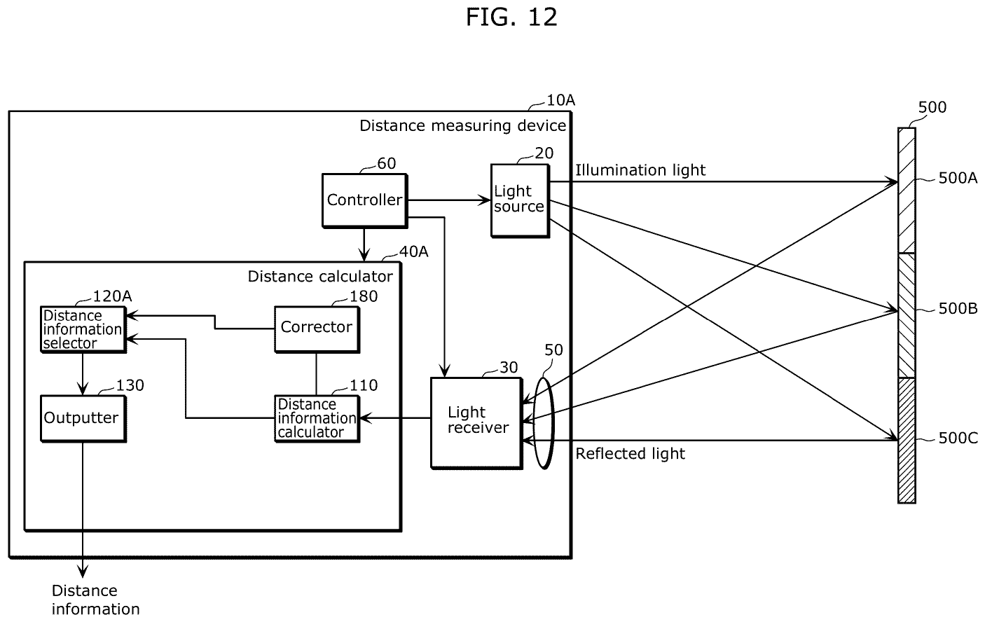

FIG. 12 is a block diagram illustrating one example of a configuration of distance measuring device 10A according to Variation 1.

As shown in FIG. 12, distance measuring device 10A is configured by changing distance calculator 40 to distance calculator 40A from distance measuring device 10 according to Embodiment 1. In addition, distance calculator 40A is configured by changing distance information selector 120 to distance information selector 120A from distance calculator 40 and adding corrector 180.

Corrector 180 corrects (i) low light intensity information that is light intensity information indicating a relatively low intensity of reflected light to corrected light intensity information indicating a greater intensity of the reflected light and (ii) high light intensity information that is light intensity information indicating a relatively high intensity of the reflected light to corrected light intensity information indicating the intensity of the reflected light as is.

Here, for example, a relatively low intensity of reflected light may be an intensity of reflected light less than a threshold, and, for example, a relatively high intensity of reflected light may be an intensity of reflected light greater than the threshold.

When an intensity of reflected light indicated by light intensity information calculated by distance information calculator 110 is less than a threshold, corrector 180 may correct the light intensity information to corrected light intensity information by, for example, performing gamma correction or offset correction.

The value of the threshold may be, for example, an intensity of reflected light required for distance information selector 120A to select selective distance information with a predetermined accuracy.

Distance information selector 120A selects one or more selective distance information items from among a plurality of pixel distance information items corresponding to respective pixels 31, based on a plurality of corrected light intensity information items corresponding to respective pixels 31.

More specifically, as the one or more selective distance information items, distance information selector 120A selects, for each of one or more bright portions included in reflected light, pixel distance information corresponding to the maximum light intensity pixel that corresponds to light intensity information indicating the maximum intensity out of one or more pixels 31 at which intensities of the reflected light indicated by corresponding corrected light intensity information items are not saturated among M pixels 31 that receive light of the bright portion.

### [Operation]

Hereinafter, operation performed by distance measuring device 10A having the above-described configuration will be described.

Distance measuring device 10A performs a second distance-measuring process, instead of the first distance-measuring process performed by distance measuring device 10 according to Embodiment 1.

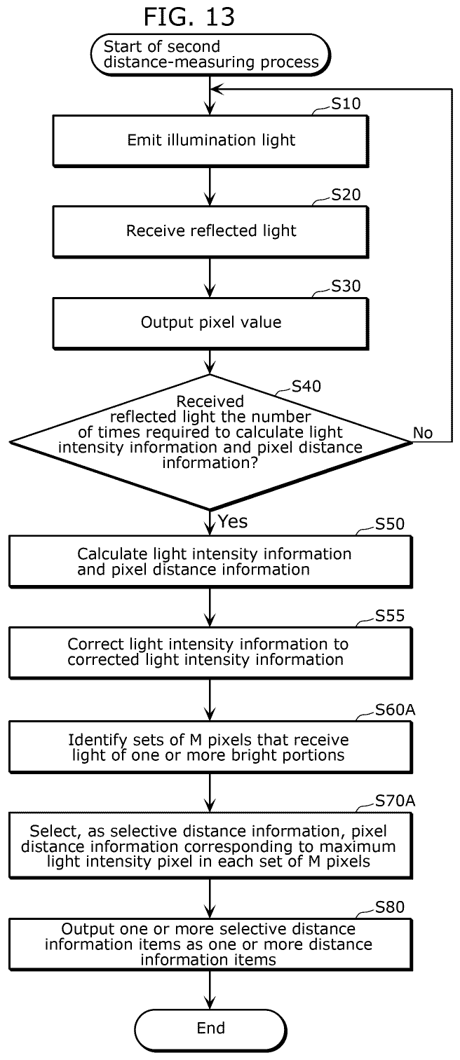

FIG. 13 is a flowchart showing a second distance-measuring process performed by distance measuring device 10A.

As shown in FIG. 13, from the first distance-measuring process according to Embodiment 1, the second distance-measuring process additionally includes a process of step S55 and includes a process of step S60A instead of the process of step S60 and a process of step S70A instead of the process of step S70.

Accordingly, the process of step S55, process of step S60A, and process of step S70A will be mainly described here for the second distance-measuring process.

When the process of step S50 ends, corrector 180 corrects the light intensity information items to corrected light intensity information items (step S55).

When the light intensity information items are corrected to the corrected light intensity information items, distance information selector 120A identifies each of sets of M pixels 31 that receives light of each of one or more bright portions included in the reflected light, based on the corrected light intensity information items corresponding to respective pixels 31 (step S60A).

When each of the sets of M pixels 31 that receives light of each of the one or more bright portions included in the reflected light is identified, distance information selector 120A selects, for each of the identified sets of M pixels 31, as selective distance information, pixel distance information corresponding to the maximum light intensity pixel that corresponds to corrected light intensity information indicating the maximum intensity out of one or more pixels 31 at which intensities of reflected light indicated by corresponding corrected light intensity information items are not saturated among the set of M pixels 31 that receives light of the bright portion (step S70A).

When the process of step S70A ends, the second distance-measuring process proceeds to the process of step S80.

### [Study]

Compared to the case where light intensity information is not corrected by corrector 180, distance measuring device 10A can select selective distance information with much more accuracy.

Therefore, compared to the case where light intensity information is not corrected by corrector 180, distance measuring device 10A can output distance information that is much more accurate.

### Variation 2

Hereinafter, a distance measuring device according to Variation 2 will be described. The distance measuring device according to Variation 2 has a partly changed configuration from the configuration of distance measuring device 10 according to Embodiment 1.

Detailed description of the distance measuring device according to Variation 2 will be omitted since the elements the same as those of distance measuring device 10 have been already described and are given the same reference numerals. Here, differences from distance measuring device 10 will be mainly described.

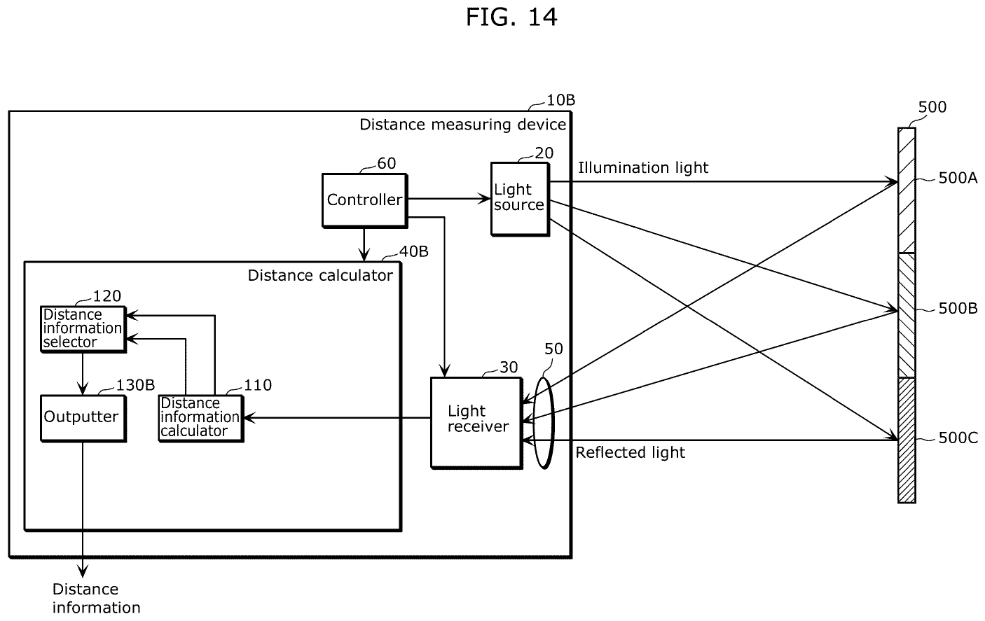

FIG. 14 is a block diagram illustrating one example of a configuration of distance measuring device 10B according to Variation 2.

As shown in FIG. 14, distance measuring device 10B is configured by changing distance calculator 40 to distance calculator 40B from distance measuring device 10 according to Embodiment 1. In addition, distance calculator 40B is configured by changing outputter 130 to outputter 130B from distance calculator 40.

Outputter 130B outputs one or more distance information items each indicating a distance to subject 500, based on one or more selective distance information items selected by distance information selector 120.

More specifically, for each of the one or more selective distance information items selected by distance information selector 120, outputter 130B calculates distance information based on the selective distance information and one or more pixel distance information items corresponding to one or more pixels (hereinafter, also referred to as “adjacent pixels”) adjacent to the maximum light intensity pixel that corresponds to the selective distance information, and outputs the one or more distance information items calculated.

In this case, when, in the calculation of the distance information, pixel 31 at which an intensity of reflected light indicated by corresponding light intensity information is saturated is present within one or more adjacent pixels, outputter 130B may calculate the distance information excluding pixel distance information corresponding to the pixel 31.

Outputter 130B may output, as distance information, a representative value of selective distance information and one or more pixel distance information items corresponding to one or more adjacent pixels, for example.

Here, the representative value may be a weighted average value, an arithmetic mean value, or a median value of selective distance information and one or more pixel distance information items corresponding to one or more adjacent pixels, for example.

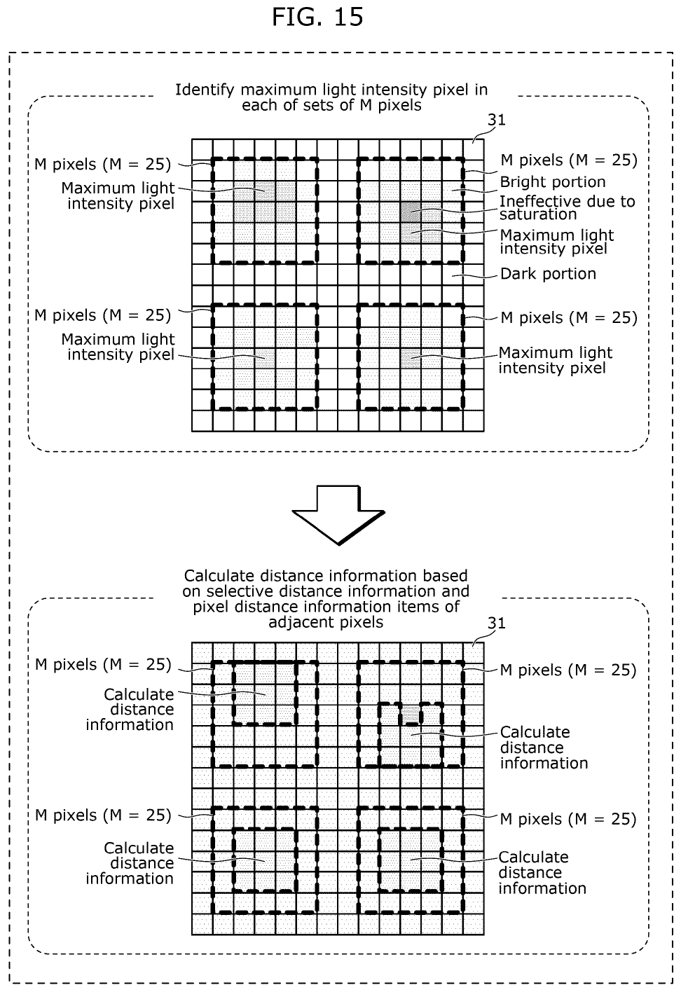

FIG. 15 is a schematic diagram illustrating one example of a state in which outputter 130B calculates, for each of one or more selective distance information items, distance information based on the selective distance information and one or more pixel distance information items corresponding to one or more adjacent pixels.

### [Study]

Distance measuring device 10B can output distance information that is much more accurate than the case where one or more selective distance information items that are output as they are as one or more distance information items.

### Variation 3

Hereinafter, a distance measuring device according to Variation 3 will be described. The distance measuring device according to Variation 3 has a partly changed configuration from the configuration of distance measuring device 10 according to Embodiment 1.

Detailed description of the distance measuring device according to Variation 3 will be omitted since the elements the same as those of distance measuring device 10 have been already described and are given the same reference numerals. Here, differences from distance measuring device 10 will be mainly described.

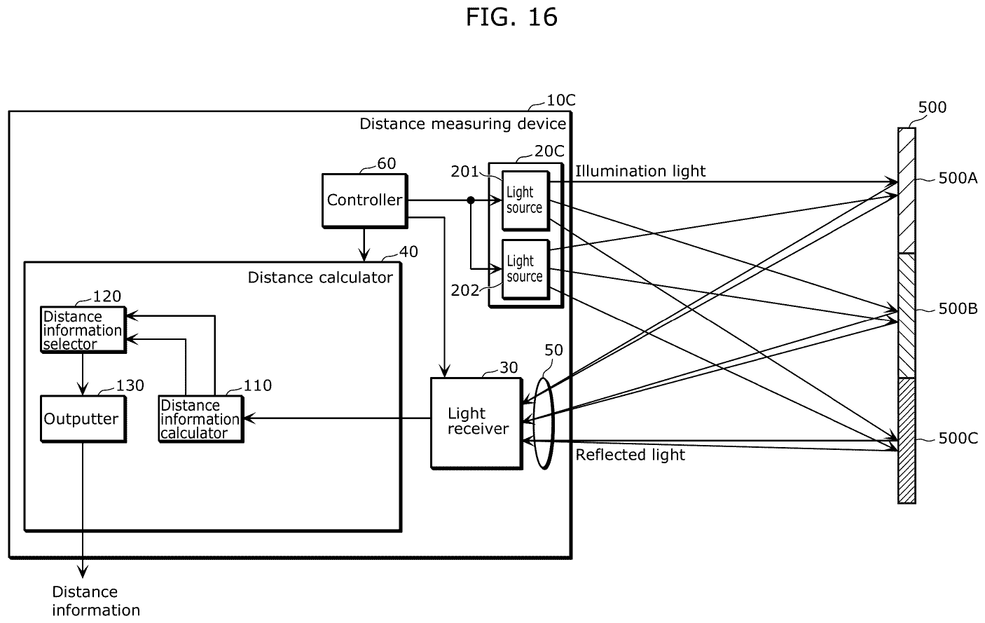

FIG. 16 is a block diagram illustrating one example of a configuration of distance measuring device 10C according to Variation 3.

As shown in FIG. 16, distance measuring device 10C is configured by changing light source 20 to light source 20C from distance measuring device 10 according to Embodiment 1.

Light source 20C includes first light source 201 that emits first illumination light including one or more bright portions and second light source 202 that emits second illumination light including one or more bright portions whose pattern is different from the pattern of the one or more bright portions of the first illumination light.

First light source 201 and second light source 202 may, for example, alternately emit light or may, for example, simultaneously emit light.

First light source 201 and second light source 202 may be provided in the same package, for example, or need not be provided in the same package, for example.

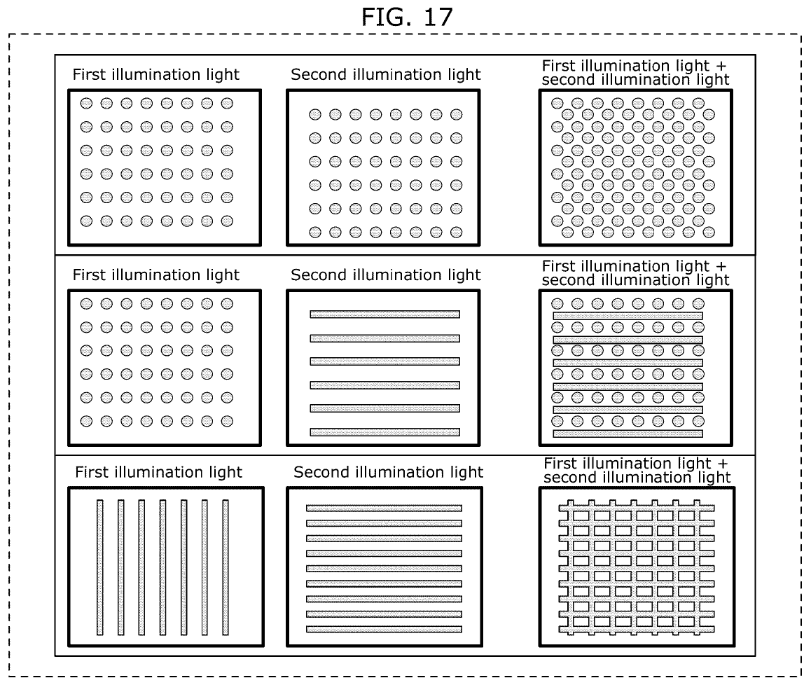

FIG. 17 illustrates an example of variations of first illumination light and second illumination light emitted by first light source 201 and second light source 202, respectively.

### [Study]

Distance measuring device 10C can emit, onto subject 500, first illumination light and second illumination light that are different in a pattern of one or more bright portions.

For this reason, patterns of one or more bright portions on subject 500 can be even more diversified compared to the case where only first illumination light is emitted onto subject 500.

Therefore, distance measuring device 10C can increase spatial resolution of one or more distance information items to be output, compared to the case where only first illumination light is emitted.

Note that although both first light source 201 and second light source 202 have been described as emitting illumination light including one or more bright portions in Variation 3, one of the two light sources, for instance, first light source 201 may emit illumination light including one or more bright portions and the other of the two light sources, for instance, second light source 202 may emit surface illumination light.

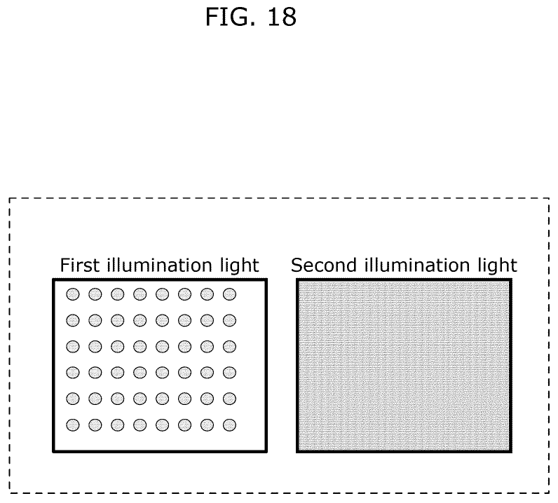

FIG. 18 illustrates one example of a state in which first light source 201 emits illumination light including one or more bright portions and second light source 202 emits surface illumination light.

Note that although light source 20C has been described as including two light sources, namely, first light source 201 and second light source 202 in Variation 3, light source 20C may include three or more light sources.

### Variation 4

Hereinafter, a distance measuring device according to Variation 4 will be described. The distance measuring device according to Variation 4 has a partly changed configuration from the configuration of distance measuring device 10 according to Embodiment 1.

Detailed description of the distance measuring device according to Variation 4 will be omitted since the elements the same as those of distance measuring device 10 have been already described and are given the same reference numerals. Here, differences from distance measuring device 10 will be mainly described.

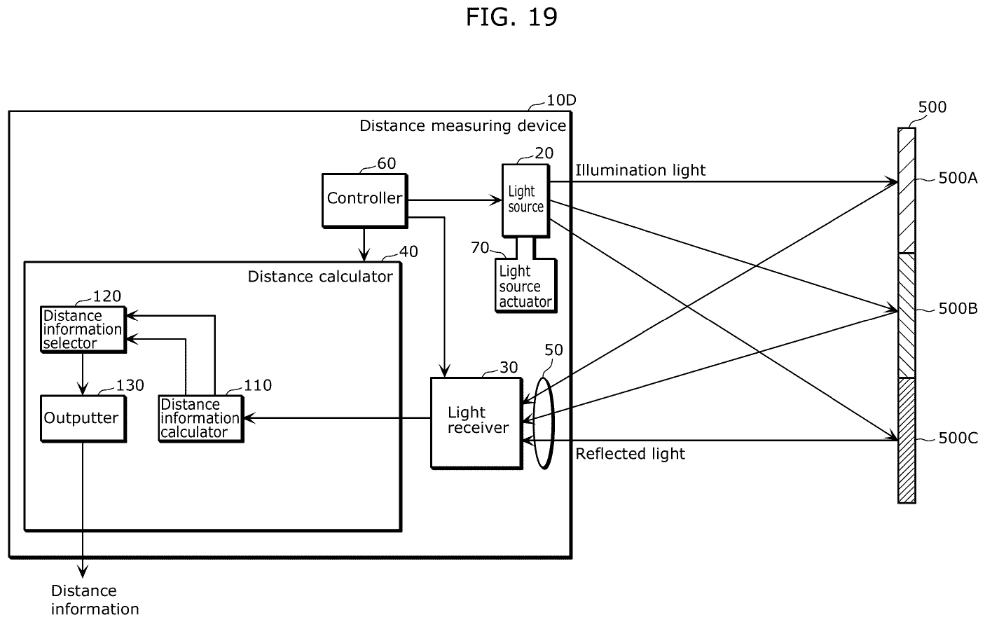

FIG. 19 is a block diagram illustrating one example of a configuration of distance measuring device 10D according to Variation 4.

As shown in FIG. 19, distance measuring device 10D is configured by adding light source actuator 70 from distance measuring device 10 according to Embodiment 1.

Light source actuator 70 actuates light source 20 such that positions of one or more bright portions on subject 500 change. As methods of actuating a light source, there are a method of directly operating the light source, a method of changing the direction of illumination light from the light source using a mirror or the like, etc.

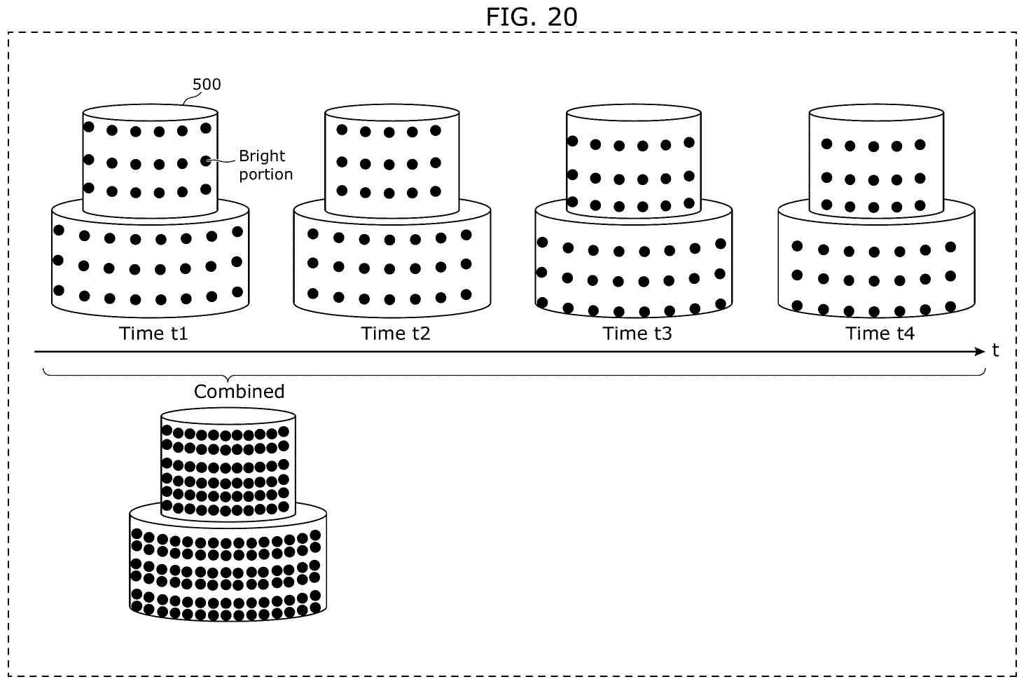

FIG. 20 is a schematic diagram illustrating one example of a state in which positions of one or more bright portions on subject 500 change by light source actuator 70 actuating light source 20.

### [Study]

Distance measuring device 10D can emit illumination light onto subject 500 such that positions of one or more bright portions change.

For this reason, patterns of one or more bright portions on subject 500 can be even more diversified compared to the case where illumination light whose one or more bright portions do not change in positions is emitted.

Therefore, distance measuring device 10D can increase spatial resolution of one or more distance information items to be output, compared to the case where illumination light whose one or more bright portions do not change in positions is emitted.

### Variation 5

Hereinafter, a distance measuring device according to Variation 5 will be described. The distance measuring device according to Variation 5 has a partly changed configuration from the configuration of distance measuring device 10 according to Embodiment 1.

Detailed description of the distance measuring device according to Variation 5 will be omitted since the elements the same as those of distance measuring device 10 have been already described and are given the same reference numerals. Here, differences from distance measuring device 10 will be mainly described.

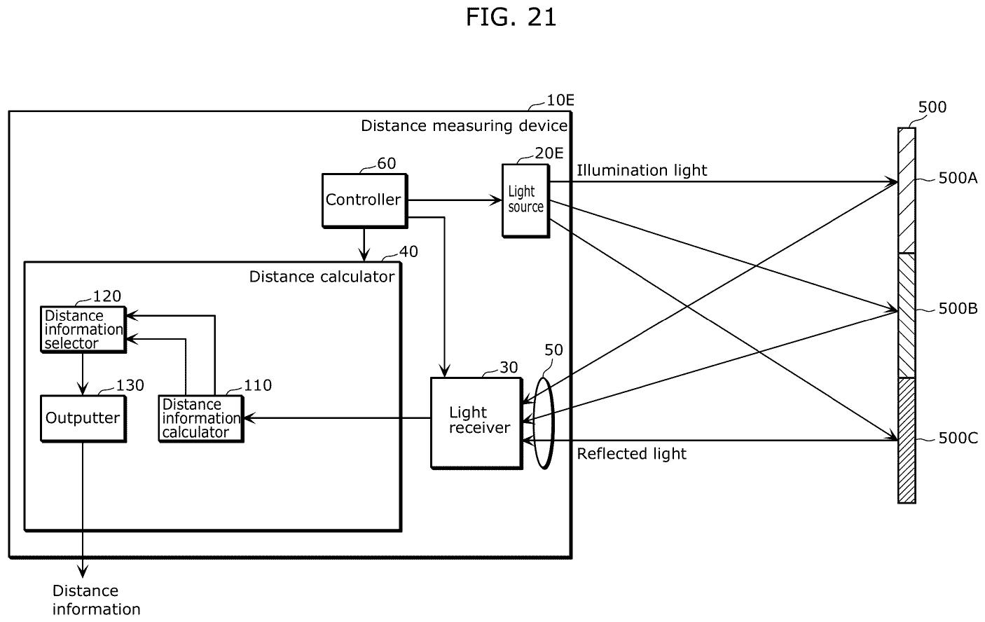

FIG. 21 is a block diagram illustrating one example of a configuration of distance measuring device 10E according to Variation 5.

As shown in FIG. 21, distance measuring device 10E is configured by changing light source 20 to light source 20E from distance measuring device 10 according to Embodiment 1.

Light source 20E switches areas in which one or more bright portions included in illumination light to be emitted are present between the entire area of an illumination range of illumination light and a particular area selected out of the entire area of the illumination range of illumination light.

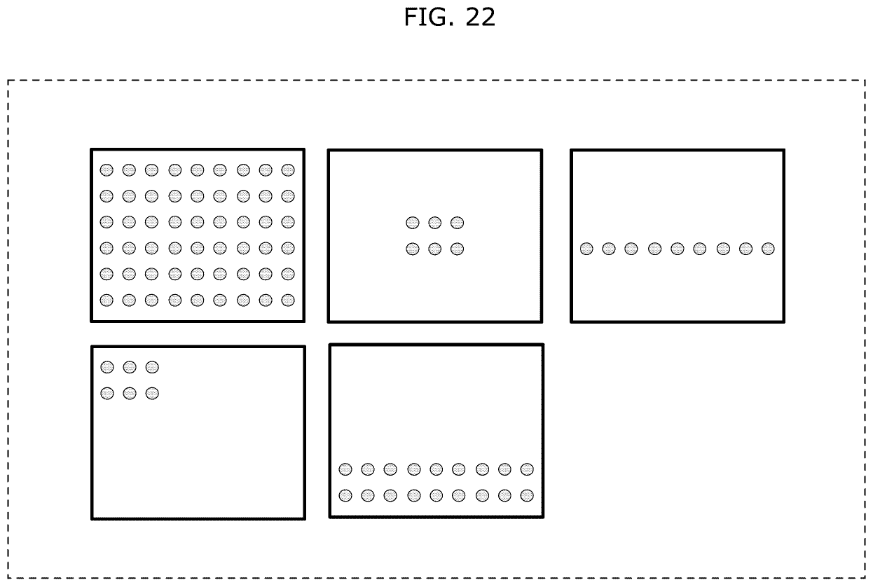

FIG. 22 is a schematic diagram illustrating one example of a state in which light source 20E switches areas of one or more bright portions included in illumination light.

### [Study]

Distance measuring device 10E can emit, onto subject 500, illumination light in which an area of one or more bright portions is included in a selected particular area.

Therefore, distance measuring device 10E can exclusively output one or more distance information items each indicating a distance to a particular area of subject 500.

### Embodiment 2

Hereinafter, a distance measuring device according to Embodiment 2 will be described. The distance measuring device according to Embodiment 2 has a partly changed configuration from the configuration of distance measuring device 10 according to Embodiment 1.

Detailed description of the distance measuring device according to Embodiment 2 will be omitted since the elements the same as those of distance measuring device 10 have been already described and are given the same reference numerals. Here, differences from distance measuring device 10 will be mainly described.

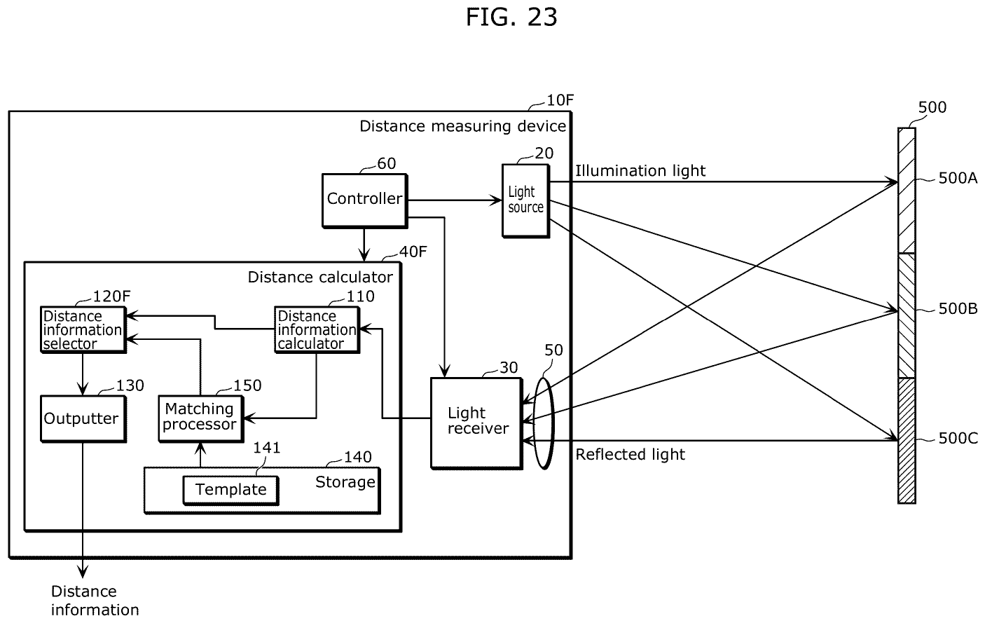

FIG. 23 is a block diagram illustrating one example of a configuration of distance measuring device 10F according to Embodiment 2.

As shown in FIG. 23, distance measuring device 10F is configured by changing distance calculator 40 to distance calculator 40F from distance measuring device 10 according to Embodiment 1. In addition, distance calculator 40F is configured by changing distance information selector 120 to distance information selector 120F from distance calculator 40, and adding storage 140 and matching processor 150.

Storage 140 stores template 141 pertaining to intensity distribution of reflected light in one or more bright portions included in the reflected light of illumination light emitted from light source 20.

Here, storage 140 is described as a storage that stores templates 141 each indicating intensity distribution of reflected light.

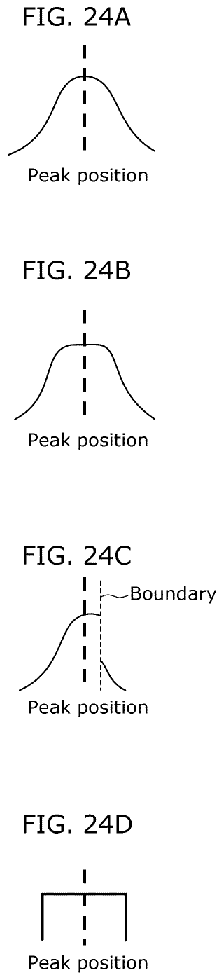

Each of FIG. 24A through FIG. 24D is template 141 stored in storage 140 and is an image illustration showing a mere example of template 141 when intensity distribution of reflected light is one-dimensional.

Template 141 shown in FIG. 24A is an example of a template indicating one example of intensity distribution of reflected light which corresponds to the case where the intensity of the reflected light is not saturated at the peak position of the intensity of reflected light. Template 141 shown in FIG. 24B is an example of a template indicating one example of intensity distribution of reflected light which corresponds to the case where the intensity of reflected light is saturated at the peak position and at a position in the vicinity of the peak position of the intensity of the reflected light. Template 141 shown in FIG. 24C is an example of a template indicating one example of intensity distribution of reflected light which corresponds to the case where a boundary with an area in which reflectance is different is present in the close vicinity of the peak position of the intensity of reflected light. Template 141 shown in FIG. 24D is an example of a template indicating one example of intensity distribution of reflected light which corresponds to the case where the intensity distribution of reflected light is in the shape of a quadrilateral.

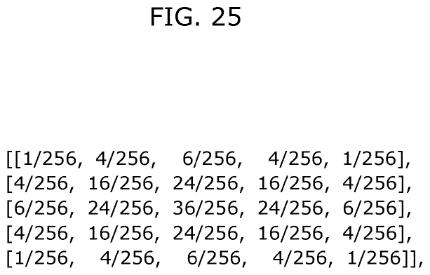

FIG. 25 is an image illustration showing one example of template 141 stored in storage 140 when intensity distribution of reflected light is two-dimensional.

Template 141 shown in FIG. 25 is an example of a template indicating one example of intensity distribution of reflected light which corresponds to the case where the intensity distribution of reflected light is a 5×5 Gaussian kernel with the peak position of the intensity of reflected light in the center.

Going back to FIG. 23 again to continue with description of distance measuring device 10F.

Matching processor 150 calculates, for each of a plurality of pixels 31 included in pixel array 32, a similarity degree indicating a degree of similarity between (i) intensity distribution of reflected light indicated by N (N is an integer of two or more) light intensity information items corresponding to N pixels consisting of the pixel and N−1 pixels surrounding the pixel and (ii) intensity distribution of reflected light indicated by template 141 stored in storage 140.

Matching processor 150 may calculate, for each of the plurality of pixels 31 included in pixel array 32, N light intensity information items to be used for calculating a similarity degree by performing a filtering process on the N light intensity information items, for example.

For example, when template 141 stored in storage 140 is a 5×5 Gaussian kernel shown in FIG. 25, the filtering process to be performed by matching processor 150 may be a process to be performed, for each of the plurality of pixels 31 included in pixel array 32, on 25 light intensity information items that correspond to 25 pixels 31 positioned in a range in which verticals (columns)×horizontals (rows) are arranged 5×5 with the pixel at the center.

Here, the filtering process may be separated into a vertical filtering process and a horizontal filtering process.

Moreover, the filtering process may perform normalization as a pretreatment.

Matching processor 150 may perform, for example, for each of the plurality of pixels 31 included in pixel array 32, a matching process of matching intensity distribution of reflected light indicated by N light intensity information items on which filtering processes have been performed with intensity distribution of reflected light indicated by template 141 stored in storage 140, to calculate a similarity degree between the intensity distribution of the reflected light indicated by the N light intensity information items and the intensity distribution of reflected light indicated by template 141 stored in storage 140.

Here, the matching process may be, for example, a matching process using a sum of absolute difference (SAD) method, a sum of squared difference (SSD) method, a normalized cross correlation (NCC) method, a phase only correlation (POC) method, or other methods.

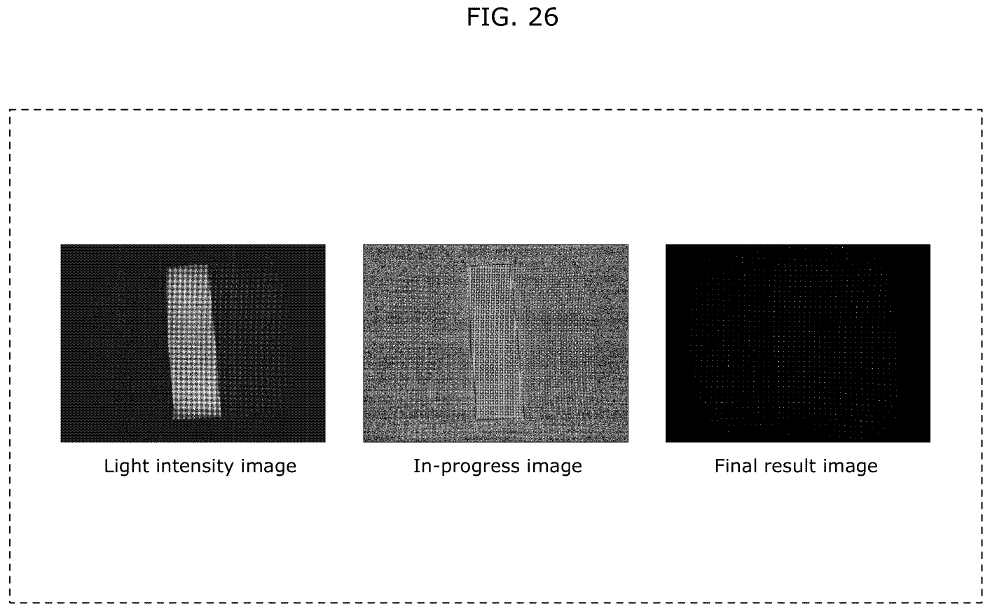

FIG. 26 is a schematic diagram illustrating one example of a state in which matching processor 150 performs a matching process.

The left-side diagram in FIG. 26 shows a light intensity image in which intensities of reflected light indicated by a plurality of light intensity information items corresponding to the plurality of pixels 31 that constitute pixel array 32 are mapped in an array. In this light intensity image, shades of dots are shown in accordance with the intensities of reflected light. Dots are shown whiter for greater intensities of reflected light.

The middle diagram in FIG. 26 is an in-progress image showing a state in which matching processor 150 is still in progress of performing matching processes. In this in-progress image, white areas correspond to areas in which similarity degrees are relatively high.

The right-side diagram in FIG. 26 is a final result image showing a state of results of matching processes performed by matching processor 150. In this final result image, each of white dots corresponds to pixel 31 having the highest similarity degree in each of one or more bright portions included in reflected light. In other words, in the final result image, each white dot corresponds to pixel 31 corresponding to the peak position of the intensity of reflected light in each of the one or more bright portions included in the reflected light.

As shown in FIG. 26, matching processor 150 may identify pixel 31 that corresponds to the peak position of the intensity of reflected light in each of the one or more bright portions included in the reflected light.

Going back to FIG. 23 again to continue with description of distance measuring device 10F.

Distance information selector 120F selects, as one or more selective distance information items, pixel distance information items each corresponding to pixel 31 having a similarity degree that satisfies a predetermined condition among the plurality of pixels 31.

Here, the predetermined condition may be, for example, a condition that a similarity degree is greater than a predetermined threshold. Moreover, when matching processor 150 is to identify pixel 31 that corresponds to the peak position of the intensity of reflected light in one or more of bright portions included in reflected light, the predetermined condition may be, for example, a condition that pixel 31 corresponds to the peak position of the intensity of reflected light which is identified by matching processor 150.

### [Study]

It is typically known that distance information calculated based on a pixel value of a pixel positioned in a portion in which an intensity of reflected light is relatively high is much more accurate than distance information calculated based on a pixel value of a pixel positioned in a portion in which an intensity of the reflected light is relatively low.

According to distance measuring device 10F having the above-described configuration, each of one or more distance information items to be calculated is calculated based on a pixel value of pixel 31 corresponding to the peak position of the intensity of reflected light in each of one or more bright portions included in reflected light.

Therefore, distance measuring device 10F can output each of one or more distance information items to be calculated as distance information that is much more accurate than distance information calculated not based on a pixel value of pixel 31 corresponding to the peak position of the intensity of reflected light.

Note that although matching processor 150 has been described as performing a matching process for each of pixels 31 included in pixel array 32 in Embodiment 2, matching processor 150 need not necessarily be configured to perform a matching process for each of pixels 31 included in pixel array 32.

Matching processor 150 may perform a matching process for each of pixels 31 positioned at fixed intervals in pixel array 32 in accordance with, for example, shapes of one or more bright portions in illumination light and/or intervals at which the one or more bright portions are positioned.

Moreover, when a matching process is a process of outputting, in addition to a similarity degree that is a matching result, a shift amount to a position at which the similarity degree reaches the maximum value (for example, when a matching process using the POC method is performed), matching processor 150 may omit performing a matching process on a pixel present between the position of the center pixel when the matching process was performed and the position indicated by the output shift amount.

In addition, an input to matching processor 150 may be pixel distance information instead of light intensity information.

### Variation 6

Hereinafter, a distance measuring device according to Variation 6 will be described. The distance measuring device according to Variation 6 has a partly changed configuration from the configuration of distance measuring device 10F according to Embodiment 2.

Detailed description of the distance measuring device according to Variation 6 will be omitted since the elements the same as those of distance measuring device 10F have been already described and are given the same reference numerals. Here, differences from distance measuring device 10F will be mainly described.

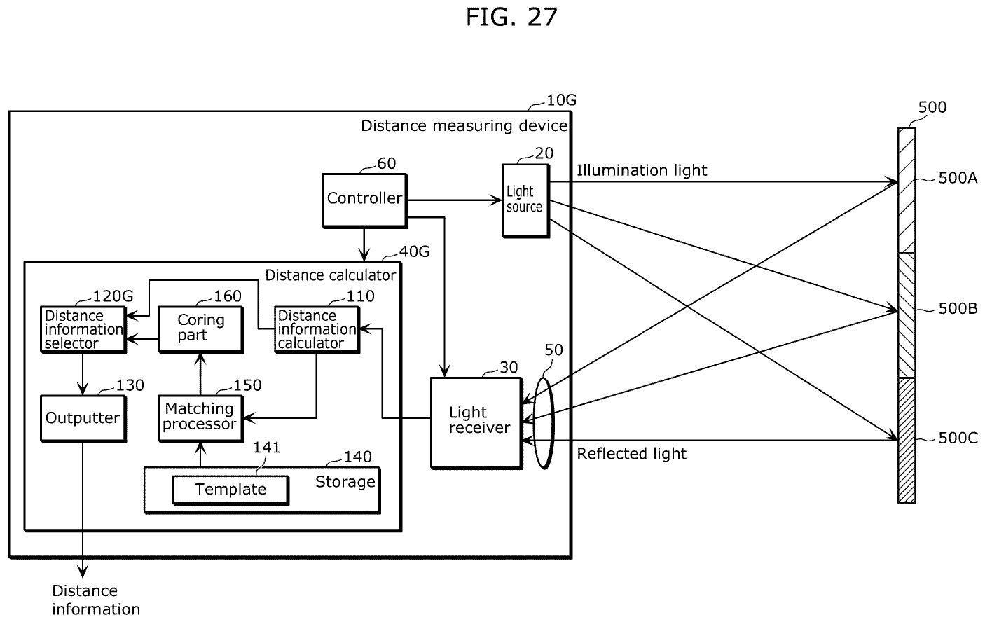

FIG. 27 is a block diagram illustrating one example of a configuration of distance measuring device 10G according to Variation 6.

As shown in FIG. 27, distance measuring device 10G is configured by changing distance calculator 40F to distance calculator 40G from distance measuring device 10F according to Embodiment 2. In addition, distance calculator 40G is configured by adding coring part 160 and changing distance information selector 120F to distance information selector 120G from distance calculator 40F.

Coring part 160 performs a coring process on a similarity degree calculated by matching processor 150 to calculate a core similarity degree.

Distance information selector 120G performs the same process as distance information selector 120F, replacing a similarity degree with a core similarity degree. In other words, distance information selector 120G selects, as one or more distance information items, pixel distance information items each corresponding to pixel 31 whose core similarity degree satisfies a predetermined condition among the plurality of pixels 31.

### [Study]

Distance measuring device 10G calculates one or more distance information items using core similarity degrees.

Therefore, distance measuring device 10G can output distance information that is more accurate than one or more distance information items calculated using similarity degrees.

### Variation 7

Hereinafter, a distance measuring device according to Variation 7 will be described. The distance measuring device according to Variation 7 has a partly changed configuration from the configuration of distance measuring device 10F according to Embodiment 2.

Detailed description of the distance measuring device according to Variation 7 will be omitted since the elements the same as those of distance measuring device 10F have been already described and are given the same reference numerals. Here, differences from distance measuring device 10F will be mainly described.

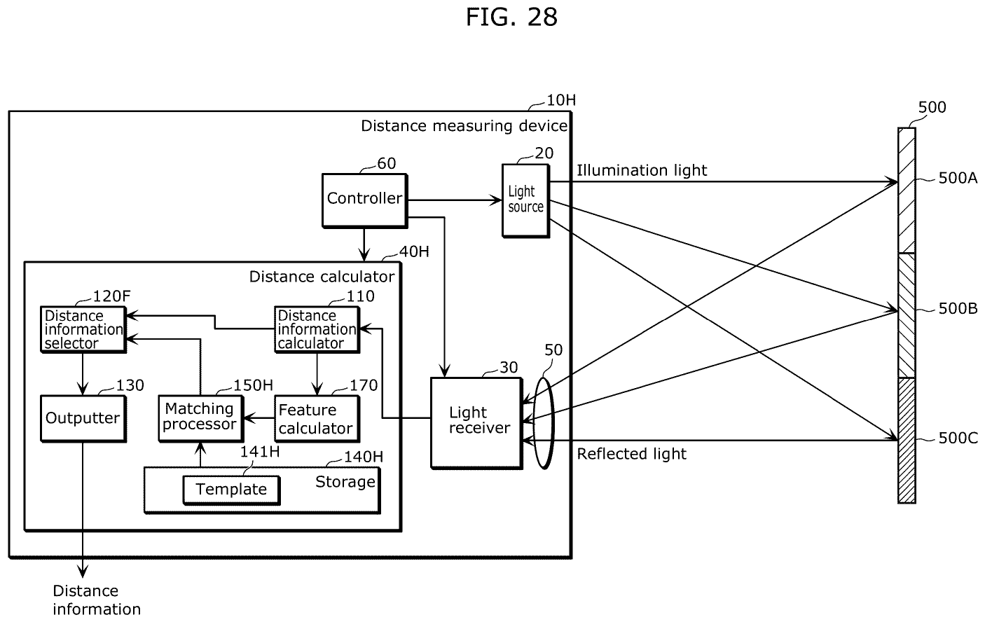

FIG. 28 is a block diagram illustrating one example of a configuration of distance measuring device 10H according to Variation 7.

As shown in FIG. 28, distance measuring device 10H is configured by changing distance calculator 40F to distance calculator 40H from distance measuring device 10F according to Embodiment 2. Moreover, distance calculator 40H is configured by adding feature calculator 170 and changing storage 140 and matching processor 150 to storage 140H and matching processor 150H, respectively, from distance calculator 40F.

Feature calculator 170 calculates, for each of a plurality of pixels 31 included in pixel array 32, features of intensities of reflected light indicated by N (N is an integer of two or more) light intensity information items corresponding to N pixels consisting of the pixel and N−1 pixels surrounding the pixel.

Here, feature calculator 170 may calculate a feature using, for example, a scale-invariant feature transform (SIFT) method, a speeded-up robust features (SURF) method, an oriented FAST and rotated BRIEF (ORB) method, a features from accelerated segment test (FAST) method, a binary robust independent elementary features (BRIEF) method, a binary robust invariant scalable keypoints (BRISK) method, or other methods.

From storage 140 according to Embodiment 2, storage 140H is configured to change a template to be stored from template 141 to template 141H. Templates 141H pertain to features of intensities of reflected light in one or more bright portions in reflected light of illumination light emitted by light source 20.

Here, storage 140H is described as a storage that stores templates 141H indicating features of intensities of reflected light.

For each of a plurality of pixels 31 included in pixel array 32, matching processor 150H calculates a similarity degree indicating a degree of similarity between a feature calculated by feature calculator 170 and a feature of an intensity of reflected light indicated by template 141H stored in storage 140H.

Matching processor 150H may calculate a similarity degree using, for example, L1 distance, L2 distance, a Hamming distance, or other methods.

### [Study]

In the same manner as distance measuring device 10F according to Embodiment 2, in distance measuring device 10H, each of one or more distance information items to be calculated is calculated based on the pixel value of pixel 31 that corresponds to the peak position of the intensity of reflected light in each of one or more bright portions included in the reflected light.

Therefore, distance measuring device 10H can output each of one or more distance information items to be calculated as, in the same manner as distance measuring device 10F, distance information that is much more accurate than distance information calculated not based on pixel 31 that corresponds to the peak position of the intensity of reflected light.

Note that although matching processor 150H has been described as performing a matching process for each of pixels 31 included in pixel array 32 in Variation 7, matching processor 150H need not necessarily be configured to perform a matching process for each of pixels 31 included in pixel array 32.

Matching processor 150H may perform a matching process for each of pixels 31 positioned at fixed intervals in pixel array 32 in accordance with, for example, shapes of one or more bright portions in illumination light and/or intervals at which the one or more bright portions are positioned.

In addition, an input to matching processor 150H may be pixel distance information instead of light intensity information.

### Variation 8

Hereinafter, a distance measuring device according to Variation 8 will be described. The distance measuring device according to Variation 8 has a partly changed configuration from the configuration of distance measuring device 10H according to Variation 7.

Detailed description of the distance measuring device according to Variation 8 will be omitted since the elements the same as those of distance measuring device 10H have been already described and are given the same reference numerals. Here, differences from distance measuring device 10H will be mainly described.

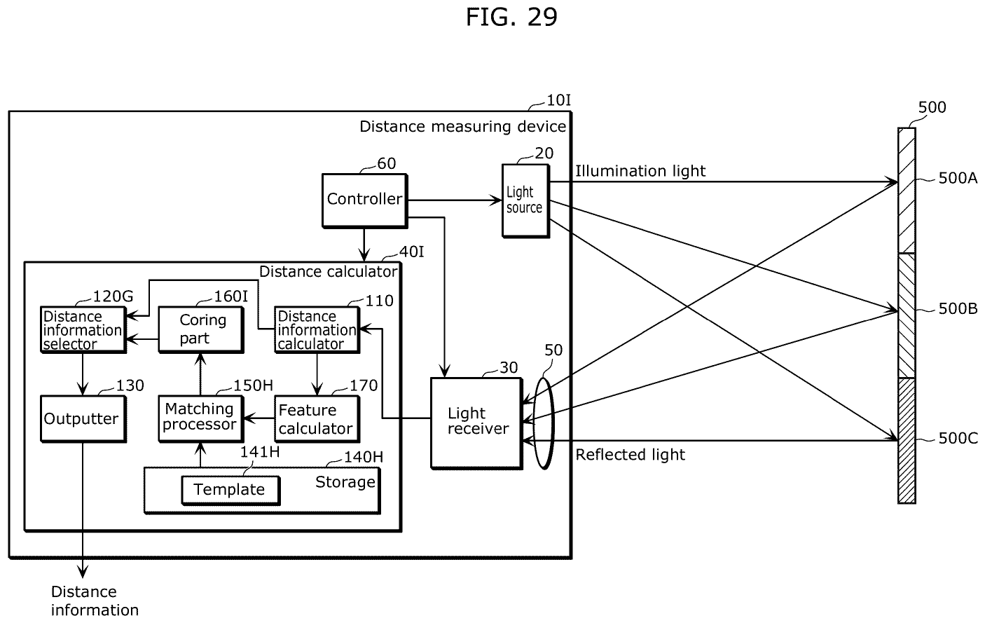

FIG. 29 is a block diagram illustrating one example of a configuration of distance measuring device 10I according to Variation 8.

As shown in FIG. 29, distance measuring device 10I is configured by changing distance calculator 40H to distance calculator 40I from distance measuring device 10H according to Variation 7. In addition, distance calculator 40I is configured by adding coring part 160I and changing distance information selector 120F to distance information selector 120G from distance calculator 40H.

Coring part 160I performs a coring process on a similarity degree calculated by matching processor 150H to calculate a core similarity degree.

### [Study]

Distance measuring device 10I calculates one or more distance information items using core similarity degrees.

Therefore, distance measuring device 10I can output distance information that is more accurate than one or more distance information items calculated using similarity degrees.

### Variation 9

Hereinafter, a distance measuring device according to Variation 9 will be described. The distance measuring device according to Variation 9 has a partly changed configuration from the configuration of distance measuring device 10F according to Embodiment 2.

Detailed description of the distance measuring device according to Variation 9 will be omitted since the elements the same as those of distance measuring device 10F have been already described and are given the same reference numerals. Here, differences from distance measuring device 10F will be mainly described.

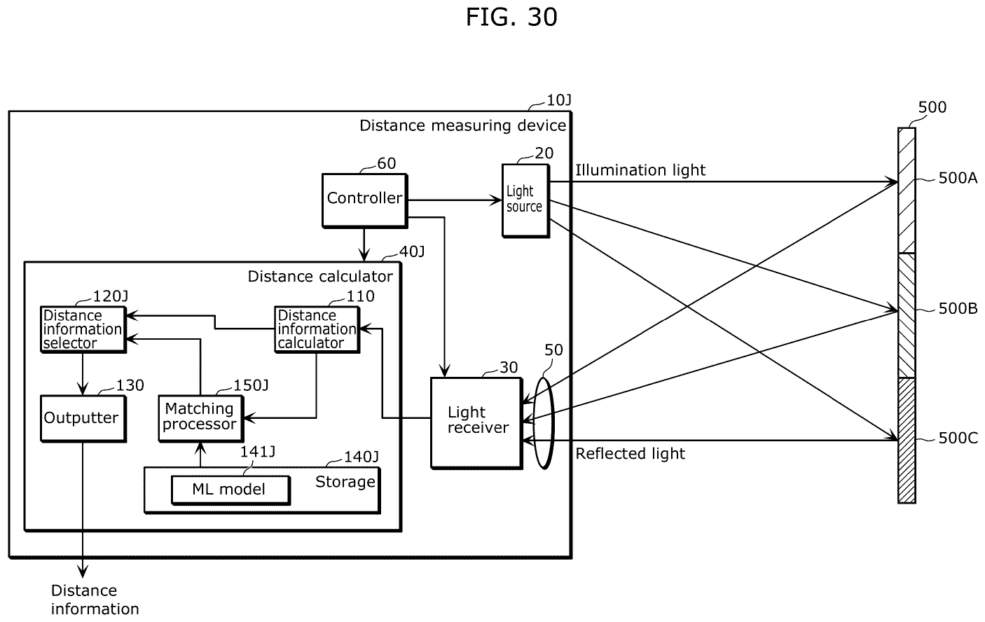

FIG. 30 is a block diagram illustrating one example of a configuration of distance measuring device 10J according to Variation 9.

As shown in FIG. 30, distance measuring device 10J is configured by changing distance calculator 40F to distance calculator 40J from distance measuring device 10F according to Embodiment 2. Moreover, distance calculator 40J is configured by changing distance information selector 120F, storage 140, and matching processor 150 to distance information selector 120J, storage 140J, and matching processor 150J, respectively, from distance calculator 40F.

Storage 140J stores machine learning model 141J trained in advance to output, in response to an input of N (N is an integer of two or more) light intensity information items corresponding to, among a plurality of pixels 31 that constitute pixel array 32, N pixels 31 consisting of one optional pixel 31 and N−1 pixels 31 surrounding the one optional pixel 31, a confidence level indicating a degree of confidence that pixel distance information corresponding to the one optional pixel 31 is one of one or more selective distance information items selected by distance information selector 120J.

Machine learning model 141J may be, for example, MobileNet (V1, V2, V3, etc.)+solid state drive (SSD), You Only Look Once (YOLO), EfficientDet, other object detection models, or machine learning models other than object detection models.

For each of the plurality of pixels 31 included in pixel array 32, matching processor 150J uses machine learning model 141J to calculate the confidence level of pixel 31.

Distance information selector 120J selects, as one or more selective distance information items, pixel distance information items each corresponding to pixel 31 whose confidence level satisfies a predetermined condition among the plurality of pixels 31.

Here, the predetermined condition may be, for example, a condition that the confidence level is greater than a predetermined threshold.

### [Study]

In the same manner as distance measuring device 10F according to Embodiment 2, in distance measuring device 10J, each of one or more distance information items to be calculated is calculated based on the pixel value of pixel 31 corresponding to the peak position of the intensity of reflected light in each of one or more bright portions included in the reflected light.

Therefore, distance measuring device 10J can output each of one or more distance information items to be calculated as, in the same manner as distance measuring device 10F, distance information that is much more accurate than distance information calculated not based on pixel 31 corresponding to the peak position of the intensity of reflected light.

Note that although matching processor 150J has been described as performing a matching process for each of pixels 31 included in pixel array 32 in Variation 9, matching processor 150J need not necessarily be configured to perform a matching process for each of pixels 31 included in pixel array 32.

Matching processor 150J may perform a matching process for each of pixels 31 positioned at fixed intervals in pixel array 32 in accordance with, for example, shapes of one or more bright portions in illumination light and/or intervals at which the one or more bright portions are positioned.

### Variation 10

Hereinafter, a distance measuring device according to Variation 10 will be described. The distance measuring device according to Variation 10 has a partly changed configuration from the configuration of distance measuring device 10J according to Variation 9.

Detailed description of the distance measuring device according to Variation 10 will be omitted since the elements the same as those of distance measuring device 10J have been already described and are given the same reference numerals. Here, differences from distance measuring device 10J will be mainly described.

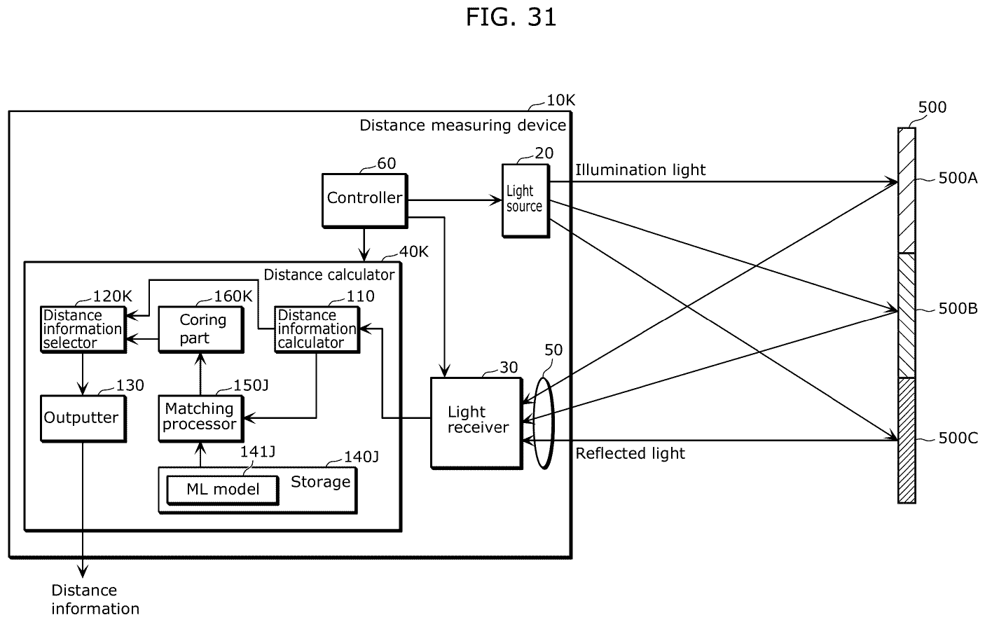

FIG. 31 is a block diagram illustrating one example of a configuration of distance measuring device 10K according to Variation 10.

As shown in FIG. 31, distance measuring device 10K is configured by changing distance calculator 40J to distance calculator 40K from distance measuring device 10J according to Variation 9. In addition, distance calculator 40K is configured by adding coring part 160K and changing distance information selector 120F to distance information selector 120K from distance calculator 40J.

Coring part 160K performs a coring process on a confidence level calculated by matching processor 150J to calculate a core confidence level.

Distance information selector 120K performs the same process as distance information selector 120J, replacing a confidence level with a core confidence level. In other words, distance information selector 120K selects, as one or more selective distance information items, pixel distance information items each corresponding to pixel 31 whose core confidence level satisfies a predetermined condition among the plurality of pixels 31.

Here, the predetermined condition may be, for example, a condition that the core confidence level is greater than a predetermined threshold.

### [Study]

Distance measuring device 10K calculates one or more distance information items using core confidence levels.

Therefore, distance measuring device 10K can output distance information that is much more accurate than one or more distance information items calculated using confidence levels.

### [Supplementary Information]

Hereinbefore, the distance measuring device according to one aspect of the present disclosure has been described based on Embodiments 1 to 2 and Variations 1 to 10, but the present disclosure is not limited to these embodiments and variations. The scope of one or more aspects of the present disclosure may encompass embodiments and/or variations to which various modifications that may be conceived by those skilled in the art are made and embodiments achieved by combining elements in different embodiments and/or variations, as long as the resultant embodiments do not depart from the spirit of the present disclosure.

### INDUSTRIAL APPLICABILITY

The present disclosure is widely applicable to distance measuring devices and the like.

1. A distance measuring device that outputs one or more distance information items each indicating a distance to a subject, the distance measuring device comprising:
a light source that emits illumination light including one or more bright portions having luminance higher than ambient luminance;
a light receiver that includes a pixel array in which pixels are arranged in a matrix, the pixels each sequentially outputting pixel values that are based on exposure amounts;
a distance information calculator that calculates, for each of the pixels, light intensity information and pixel distance information based on one or more of the pixel values sequentially output by the pixel when the light receiver receives reflected light that is the illumination light reflected off the subject, the light intensity information indicating an intensity of the reflected light at the pixel, the pixel distance information indicating a distance from the pixel to the subject;
a distance information selector that selects, based on the light intensity information items corresponding to the pixels, one or more selective distance information items from among the pixel distance information items corresponding to the pixels; and
an outputter that outputs the one or more distance information items, based on the one or more selective distance information items.

2. The distance measuring device according to claim 1, wherein
when the light receiver receives the reflected light, each of the one or more bright portions included in the reflected light are received by M pixels among the pixels, where M is an integer of three or more, and
as the one or more selective distance information items, the distance information selector selects, for each of the one or more bright portions included in the reflected light, the pixel distance information corresponding to a maximum light intensity pixel that corresponds to the light intensity information indicating a maximum intensity out of one or more of the pixels at which intensities of the reflected light indicated by corresponding ones of the light intensity information items are not saturated among the M pixels.

3. The distance measuring device according to claim 2, wherein
the outputter outputs the one or more selective distance information items as the one or more distance information items.

4. The distance measuring device according to claim 2, wherein
for each of the one or more selective distance information items, the outputter calculates the distance information based on the selective distance information and one or more of the pixel distance information items corresponding to one or more of the pixels adjacent to the maximum light intensity pixel corresponding to the selective distance information, and outputs the distance information calculated.

5. The distance measuring device according to claim 1, further comprising:
a corrector that corrects (i) low light intensity information that is the light intensity information indicating a relatively low intensity of the reflected light to corrected light intensity information indicating a greater intensity of the reflected light and (ii) high light intensity information that is the light intensity information indicating a relatively high intensity of the reflected light to the corrected light intensity information indicating an intensity of the reflected light as is, wherein
the distance information calculator calculates the pixel distance information for each of the pixels based on the corrected light intensity information, and
the distance information selector selects the one or more selective distance information items based on the corrected light intensity information.

6. The distance measuring device according to claim 1, wherein
the illumination light comprises first illumination light and second illumination light that are different in a pattern of the one or more bright portions, and
the light source comprises a first light source that emits the first illumination light and a second light source that emits the second illumination light.

7. The distance measuring device according to claim 6, wherein
the first light source and the second light source alternately emit light.

8. The distance measuring device according to claim 6, wherein
the first light source and the second light source simultaneously emit light.

9. The distance measuring device according to claim 1, further comprising:
a light source actuator that actuates the light source to change positions of the one or more bright portions on the subject.

10. The distance measuring device according to claim 1, further comprising:
a storage that stores a template pertaining to intensity distribution of the reflected light in the one or more bright portions included in the reflected light; and
a matching processor that calculates, for each of the pixels, a similarity degree indicating a degree of similarity between (i) intensity distribution of the reflected light indicated by N light intensity information items corresponding to N pixels consisting of the pixel and N−1 pixels surrounding the pixel, where N is an integer of two or more and (ii) the intensity distribution of the reflected light indicated by the template, the N light intensity information items each being the light intensity information, the N pixels being among the pixels, wherein
the distance information selector selects, as the one or more selective distance information items, the pixel distance information corresponding to a pixel having the similarity degree that satisfies a predetermined condition among the pixels.

11. The distance measuring device according to claim 1, further comprising:
a storage that stores a template pertaining to a feature of intensity of the reflected light in the one or more bright portions in the reflected light;
a feature calculator that calculates, for each of the pixels, features of intensities of the reflected light indicated by N light intensity information items corresponding to N pixels consisting of the pixel and N−1 pixels surrounding the pixel, where N is an integer of two or more, the N light intensity information items each being the light intensity information, the N pixels being among the pixels; and
a matching processor that calculates a similarity degree indicating a degree of similarity between the N features calculated by the feature calculator and the feature of the intensity of the reflected light indicated by the template, wherein
the distance information selector selects, as the one or more selective distance information items, the pixel distance information corresponding to a pixel having the similarity degree that satisfies a predetermined condition among the pixels.

12. The distance measuring device according to claim 10, wherein
the predetermined condition is a condition that the similarity degree is greater than a predetermined threshold.

13. The distance measuring device according to claim 10, further comprising:
a coring part that performs a coring process on the similarity degree to calculate a core similarity degree, wherein
the predetermined condition is a condition that the core similarity degree is greater than a predetermined threshold.

14. The distance measuring device according to claim 1, further comprising:
a storage that stores a machine learning model trained in advance to output, in response to an input of N light intensity information items corresponding to N pixels consisting of one optional pixel and N−1 pixels surrounding the one optional pixel among the pixels, where N is an integer of two or more, a confidence level indicating a degree of confidence that the pixel distance information corresponding to the one optional pixel is one of the one or more selective distance information items, the N light intensity information items each being the light intensity information; and
a matching processor that calculates, for each of the pixels, the confidence level of the pixel using the machine learning model, wherein
the distance information selector selects, as the one or more selective distance information items, the pixel distance information corresponding to a pixel having the confidence level that satisfies a predetermined condition among the pixels.

15. The distance measuring device according to claim 14, wherein
the predetermined condition is a condition that the confidence level is greater than a predetermined threshold.

16. The distance measuring device according to claim 14, further comprising:
a coring part that performs a coring process on the confidence level to calculate a core confidence level, wherein
the predetermined condition is a condition that the core confidence level is greater than a predetermined threshold.

17. The distance measuring device according to claim 11, wherein
the predetermined condition is a condition that the similarity degree is greater than a predetermined threshold.

18. The distance measuring device according to claim 11, further comprising:
a coring part that performs a coring process on the similarity degree to calculate a core similarity degree, wherein
the predetermined condition is a condition that the core similarity degree is greater than a predetermined threshold.
